(19) United States
(12) Patent Application Publication
(10) Pub. No.: US 2010/0332305 A1
(43) Pub. Date: Dec. 30, 2010

(54) ADVERTISING ENGINE AND NETWORK USING MOBILE DEVICES

(75) Inventors: Chris W. Higgins, Portland, OR (US); Athellina Athsani, San Jose, CA (US); Marc Davis, San Francisco, CA (US)

Correspondence Address: MPG, LLP AND YAHOO! INC., 710 LAKEWAY DRIVE, SUITE 200, SUNNYVALE, CA, 94085, US

(73) Assignee: Yahoo! Inc., Sunnyvale, CA (US)

(21) Appl. No.: 12/494,134

(22) Filed: Jun. 29, 2009

(51) Int. Cl. G06Q 30/00

(52) U.S. Cl. 705/14.16; 705/14.44; 705/14.64

(57) ABSTRACT

The embodiments described show that wireless devices can be used to distribute and/or to endorse (or promote) advertisements (ads) by individuals and by ad distributors. In one embodiment, a computer implemented method of forwarding an advertisement received on a first mobile device to a second mobile device is provided. The method includes sending the advertisement to the first mobile device, and detecting forwarding of the advertisement from the first mobile device to the second mobile device. The method also includes determining if the advertisement that was forwarded to the second mobile device includes an endorsement for the advertisement. The endorsement was generated at the first mobile device. The method further includes monitoring activity on the second mobile device regarding the advertisement when the advertisement includes the endorsement and when the advertisement does not include the endorsement.

### BACKGROUND

Advertising is used by advertisers to accomplish various business goals, ranging from building brand awareness among potential customers to facilitating online purchases of products or services. Online advertising uses the Internet and World Wide Web to deliver marketing messages to attract customers. Compared to traditional advertising that utilizes media, such as newspapers, printed materials, televisions (TVs), radios, and billboards, online advertising has many competitive advantages and has been steadily gaining popularity.

In recent years, mobile devices (or mobile communication devices), such as cell phones, and personal digital assistants (PDAs), have become more and more popular. The number of mobile device users has greatly increased worldwide. Mobile advertising, which delivers advertisements via mobile phones or other mobile devices, has a great potential of reaching a great number of people in various parts of the world. Mobile advertising is closely related to online or Internet advertising; however, its potential reach is far greater.

The current online advertising and mobile advertising lack personalized endorsement. In addition, they current mobile advertising does not fully utilize the full potential of mobile devices in advertising. It is in this context that embodiments of the present invention arise.

### SUMMARY OF THE INVENTION

The embodiments described below define wireless devices can be used to distribute and/or to endorse (or promote) advertisements (ads) by individuals and by ad distributors. In one embodiment, mobile ads are actively distributed and/or endorsed by individuals to their friends, families, and/or acquaintance and are thus more likely to be viewed. The individuals (or users) who participate in distributing and endorsing mobile ads can receive financial reward as an incentive. As mobile device users carry their mobile devices for most of their daily activities, their mobile devices can be used to receive and to distribute ads based on their environment. Mobile ad engines and methods can be set up to better match ads with targeted receivers and to assist mobile users in distributing and endorsing of ads. Thus, the excess storage and processing capabilities of wireless (or mobile) devices can be harvested to serve ads with or without the knowledge of the owners of wireless (or mobile) devices.

It should be appreciated that the present invention can be implemented in numerous ways, including as a method, a system, or a device. Several inventive embodiments of the present invention are described below.

In one embodiment, a computer implemented method of forwarding an advertisement received on a first mobile device to a second mobile device is provided. The method includes sending the advertisement to the first mobile device, and detecting forwarding of the advertisement from the first mobile device to the second mobile device. The method also includes determining if the advertisement that was forwarded to the second mobile device includes an endorsement for the advertisement. The endorsement was generated at the first mobile device. The method further includes monitoring activity on the second mobile device regarding the advertisement when the advertisement includes the endorsement and when the advertisement does not include the endorsement.

In another embodiment, a computer implemented method of receiving and forwarding advertisements using wireless devices is provided. The method includes receiving and storing a plurality of advertisements and their corresponding advertising targets. The method also includes receiving and storing registration of a plurality of mobile advertisement serving devices, and retrieving user profiles of the plurality of mobile advertisements serving devices being registered. The method further includes matching the plurality of advertisements received with the plurality of registered mobile advertisement serving devices by matching the advertising targets with the user profiles. Personalized advertisement inventories for the plurality of the registered mobile advertisement serving devices are generated based on matching results. The method additionally includes downloading the personalized advertisement inventories to the plurality of registered mobile advertisement serving devices, and sensing an environment for advertisement serving by a registered mobile advertisement-serving device. The method also includes serving at least one advertisement to at least one advertising target of the at least one advertisement from the registered mobile advertisement serving devices. The serving includes an endorsement generated at the serving mobile advertisement serving device. The method further includes displaying the at least one advertisement on the at least one advertising target.

In another embodiment, a system of receiving and distributing advertisements using wireless devices is provided. The system includes an account management system for managing account information of users of wireless devices. The account management system has a user profile module that stores user profiles of the users of wireless devices. The system also includes an advertisement management system for managing advertisements. The advertisement management system has an advertisement targeting module that stores profiles of wireless device users targeted by the advertisements stored in the advertisement management system. The system further includes an advertisement serving module for delivering advertisements to the wireless devices. The advertisement serving module accesses the account management system and the advertisement management system to match the advertisements in the advertisement management with the wireless devices by matching the user profiles of the wireless devices with the profiles of wireless devices users targeted by the advertisements stored in the advertisement system. The advertisement serving module assists users of the wireless devices in forwarding and endorsing advertisements received by the wireless devices. The advertisement serving module has a reward module that records advertisement forwarding and endorsing activities of the users of wireless devices.

In yet another embodiment, computer readable media including program instruction for forwarding an advertisement received on a first mobile device to a second mobile device are provided. The computer readable media include program instruction sending the advertisement to the first mobile device, and program instruction detecting forwarding of the advertisement from the first mobile device to the second mobile device. The computer readable media also include program instruction determining if the advertisement that was forwarded to the second mobile device includes an endorsement for the advertisement. The endorsement was generated at the first mobile device. The computer readable media further include program instruction monitoring activity on the second mobile device regarding the advertisement when the advertisement includes the endorsement and when the advertisement does not include the endorsement.

Other aspects and advantages of the invention will become apparent from the following detailed description, taken in conjunction with the accompanying drawings, illustrating by way of example the principles of the invention.

### BRIEF DESCRIPTION OF THE DRAWINGS

The embodiments of the present invention will be readily understood by the following detailed description in conjunction with the accompanying drawings, and like reference numerals designate like structural elements.

FIG. 1A shows User-B forwarding a mobile advertisement to User-B's friends, in accordance with one embodiment of the current invention.

FIG. 1B shows a forwarded mobile ad displayed in a hand-held device, in accordance with one embodiment of the present invention.

FIG. 1C illustrates an exemplary model of a communication network, in accordance with one embodiment of the present invention.

FIG. 1D shows a mobile device that receives a mobile ad and a list of mobile users that could be interested in the mobile ad, in accordance with one embodiment of the present invention.

FIG. 1E shows a process flow of forwarding (or distributing) a received mobile ad by a user, in accordance with one embodiment of the present invention.

FIG. 2A shows Vendor-A sending out a messaging or a mobile ad to past customers in his/her vicinity, in accordance with one embodiment of the present invention.

FIG. 2B shows the message or ad that Vendor-A sends to the customers, in accordance with one embodiment of the present invention.

FIG. 2C shows a process flow of identifying mobile devices as ad-distributing devices, in accordance with one embodiment of the current application.

FIG. 3A shows an illustration of an ad being displayed on a display unit in a restaurant, in accordance with one embodiment of the current invention.

FIG. 3B shows a database table of ad targeting of a crowd, in accordance with one embodiment of the current application.

FIG. 4 shows a person going through his/her daily activities with his/her mobile device, in accordance with one embodiment of the present application.

FIG. 5A shows a system configured or distributing ads by mobile device users, in accordance with one embodiment of the present invention.

FIG. 5B shows a user profile for a user of a wireless or mobile device user, User-A, in accordance with one embodiment of the present invention.

FIG. 5C shows an ad profile of an ad, in accordance with one embodiment of the present invention.

FIG. 5D shows a system configured for distributing ads by mobile device users, in accordance with another embodiment of the present invention.

FIG. 5E shows a number of messages on a mobile device, in accordance with one embodiment of the present invention.

FIG. 5F shows a skin product ad and also a message below the ad, in accordance with one embodiment of the present invention.

FIG. 5G illustrates a window with a field showing a default ad-endorsing message, in accordance with one embodiment of the present invention.

FIG. 6A shows a process flow of receiving and forwarding ads, in accordance with one embodiment of the present invention.

FIG. 6B shows a method of distributing and targeting ads to users, in accordance with one embodiment of the present invention.

FIG. 6C shows a method of distributing and targeting ads to users, in accordance with one embodiment of the present invention.

### DETAILED DESCRIPTION

As described earlier, mobile devices, such as cell phones, and PDAs, have become very popular. Due to the relative low cost of cell phones, the number of cell phones has skyrocketed to multi-billions in recent years. Cell phone service providers and cell phone manufactures offer different types of cell phones with different functionalities and features. Examples of cell phone companies that provide hardware and service include, but are not limited to, AT&T, Nokia, Samsung, Motorola, Verizon, and T-Mobile, etc. Modern cell phones have increased functionalities beyond making calls, that may include text messages, music, video, photo-taking, radio-receiving, global positioning system (GPS) navigation, Blue Tooth and/or WIFI connectivity, web-browsing, email, and instant messaging, etc. The popularity of PDAs, which are hand-held computers, with capabilities of mobile phones has also greatly increased. Examples of PDAs may include, but are not limited to, such as Palm Pilot™, Blackberries™, iPhones™, and Treo™, etc. Many PDAs employ touch screen technology.

Mobile devices, such as cell phones and PDAs, can be held by users, and are sometimes called hand-held devices. Users often carry such mobile communication devices (mobile devices) when they go through their daily lives. The availability and proximity of mobile communication devices to users make mobile devices ideal tools to receive and to transmit advertisements. Mobile devices can transmit and/or receive wireless communication signals without relying on physical landlines. As a result, mobile communication can be more easily established in rural areas with much less cost than communication systems that rely on landlines. Some rural areas of developing countries rely on cell (or cellular) phones for communication instead of the conventional land-line-based phones, which require huge capital investment to establish landlines.

As mentioned above, due to the increasing number of mobile device users, mobile advertising becomes increasingly important, because of its great potential in reaching millions of users. Also as mentioned earlier, the features of the modern mobile communication devices (or mobile devices) have greatly improved. The improved functionalities and performance of the modern mobile devices allow mobile advertising to be delivered in a variety of manners. For examples, mobile advertisement can be a mobile web banner, which appears on top of a page, or a mobile web poster, which appears at the bottom of the page banner. Mobile advertising methods may also include SMS (short message service) advertising, which delivers advertisements through short messages, and MMS (multimedia messaging service) advertising, which delivers advertising messages with multimedia objects. In addition, mobile ads can be delivered within mobile games and mobile videos, during mobile television (TV) receipt, and during full-screen interstices, where the advertisements appear while requested items of mobile content are loading up. Mobile advertising could also be delivered via audio.

As mentioned above, advertisements are used to increase sales and to build brand recognition. Advertisements are often viewed with skepticism, especially when the advertisements are from advertisers not known or unfamiliar to users. Sometimes, people do provide positive feedbacks of their experience of using certain products and/or services through casual conversation or by other forms of communication, such as email or phone calls. An endorsement of a product or service from someone a person knows and/or trusts can create positive impressions on the product and/or service being endorsed. It might even convince the person to try the product and/or service.

Although the varieties of mobile advertisements have increased, such as audios, videos, texts (or messages), or texts with images, etc., the current mobile advertisements are delivered to receivers without personalized endorsement from people known by the receivers. Endorsement of ads from people known by the ad-receivers would make the advertisements more trust-worthy, since the ad-receivers already have certain knowledge and trust of the endorsers. Their opinions could affect the impressions of the ad-receivers regarding the ads, the products, and/or the services. Such endorsement would increase the likelihood the advertisements being viewed and the likelihood that the products and services in the ads being purchased.

For example, User-A sees a mobile advertisement of a product, Product-A, and User-A likes the product. User-A might decide that some of his/her friends would like Product-A as well. User-A can then forward the mobile advertisement to these friends, and tell them that he/she really likes Product-A. User-A could further suggest checking out the advertisement. When User-A decides to forward the advertisement for Product-A to his/her friends, User-A knows which of his/her friends might be interested in the Product-A mentioned in the advertisement. In addition, User-A is likely to forward the ad only to his/her friends who would appreciate his/her advice or recommendation. Such knowledge and relationship of User-A help the advertisement to find its targeted audience. Even if User-A forwards (or sends) advertisements to his/her friends without endorsement, the advertisements would be received with additional attention from the ad-receivers due to the existing knowledge and trust (or relationship) between the users and the ad-receivers.

The relationship and trust between User-A and his/her friends would make the advertisement more appealing to the friends of User-A, especially with the personalized endorsement from User-A. The effectiveness of the forwarding and endorsement of ads would be related to the degree of trust, respect, and/or knowledge the ad-receivers have toward the ad-endorsers.

Currently, ad-forwarding and ad-endorsement are not automated, and are not rewarded. Typically, on-line and mobile advertisements are only displayed for ad-receivers to view. Sometimes ad-receivers would click on the ads to play videos/audios of the ads, to get more information, or to make purchase or ordering. Most on-line and mobile advertisements are not set up to be forwarded to other online or mobile users with personalized endorsement, unless the ads are received as emails. Even when the ads are forwarded through emails, no suggested list of online and/or mobile users to forward is provided and no reward is available for forwarding and/or endorsing the ads.

Without automated methods and systems to forward ads and to enter personalized endorsement, ads would not be forwarded. Without automated methods and systems, users might see an interesting advertisement, but would not mention the ad to his/her friends due to the difficulty and trouble of forwarding. Further, currently there is no incentive for users to endorse and forward the advertisements. There is no system and method available to track the ad-forwarding and ad-endorsement activities of users. Therefore, such users are not rewarded. Without rewards, users lack incentives to actively promote (including distributing and/or endorsing) the ads. To allow advertisers to reward ad-forwarders and ad-endorsers, systems and methods that record the ad-forwarding and ad-endorsing activities are needed.

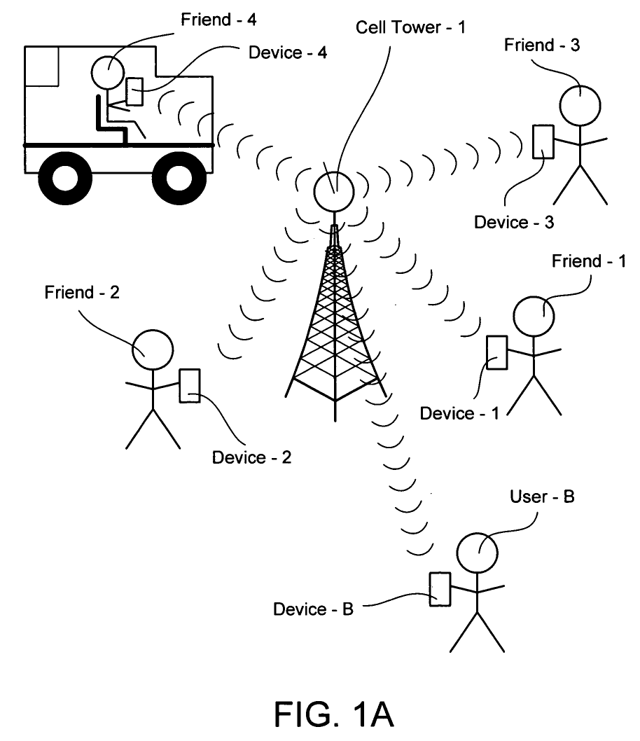

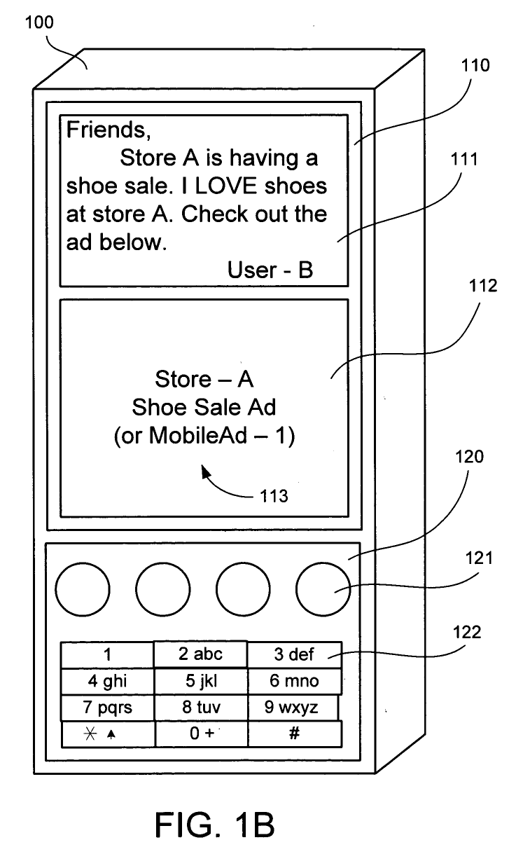

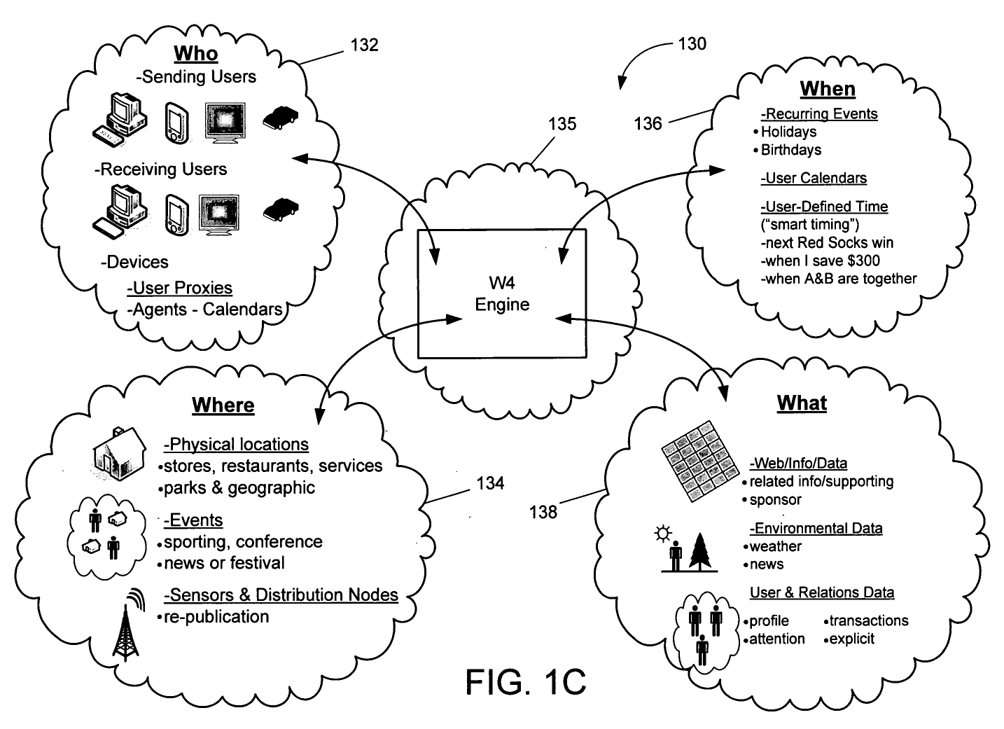

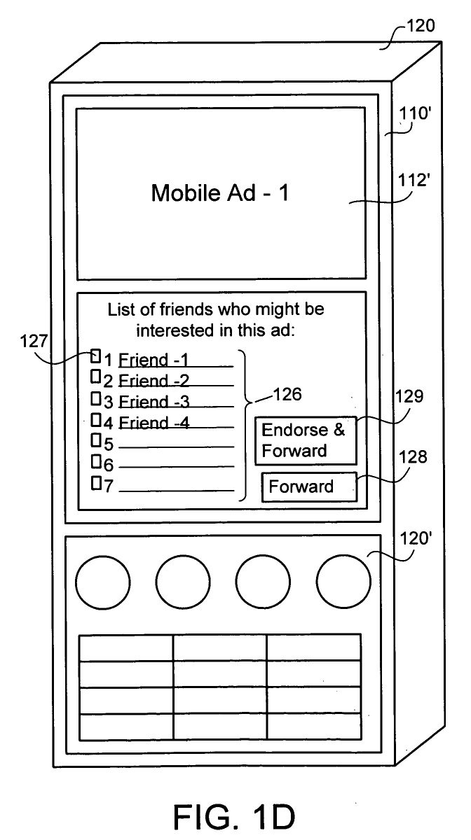

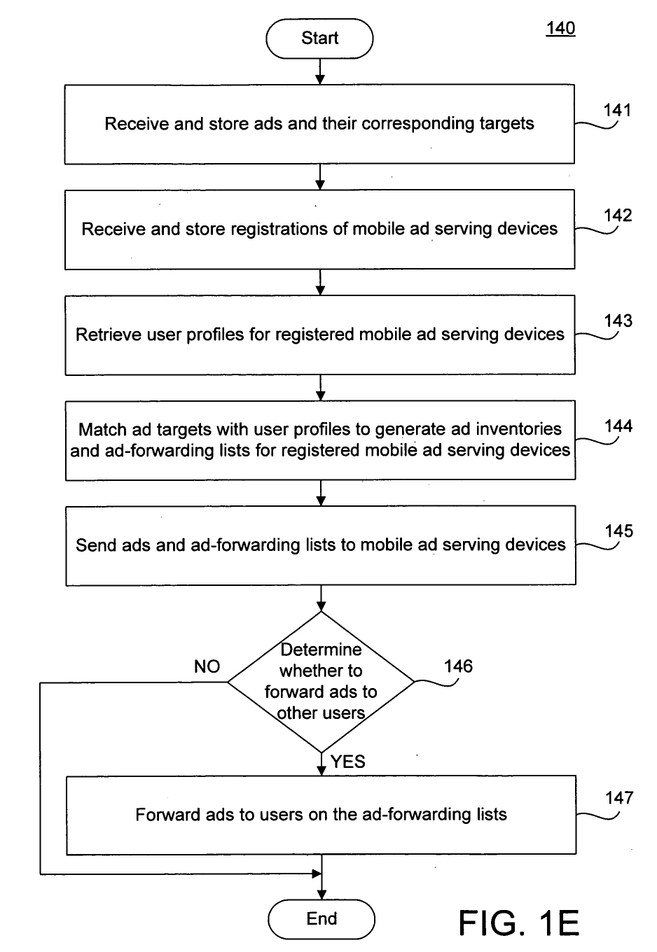

FIG. 1A shows a user, User-B, forwarding a mobile advertisement that User-B receives on User-B's hand-held device to User-B's friends, in accordance with one embodiment of the current invention. The mobile advertisement described here refers to an advertisement delivered through a mobile device. User-B receives the mobile advertisement, MobileAd-1, on a wireless device, Device-B. After viewing MobileAd-1, User-B decides to forward MobileAd-1 to a few of his friends, whom User-B thinks would be interested in the content of MobileAd-1.

In one embodiment, a system and a method are set up for receivers of mobile ads to easily forward received mobile ads to selected mobile devices (or selected ad-targets). In one embodiment, the system and method provide lists of targets for forwarding ads. In another embodiment, the system and method enable ad receivers to forward ads to selected ad-targets with endorsements. In yet another embodiment, the system and method track the ad-forwarding and ad-endorsing activities.

When User-B forwards MobileAd-1 to his/her friends, User-B can simply forward the ad without endorsing the ad. Under this condition, the ad receivers, Friend-1, Friend-2, Friend-3, and Friend-4, receive MobileAd-1 from User-B and become aware that their friend, User-B, wants them to view the ad. Most likely, when User-B decides to forward MobileAd-1 to his/her friends, User-B would enter a personal message with the forwarded ad. The personal message of User-B can simply asks the receivers to “Check this out!” or can have User-B's personal endorsement. For example, the message could be “Hi, I used this product XYZ before and I really like it. Check out the ad!.” Even the simple message of “Check this out!” would signal certain level of endorsement from User-B. The receivers would think that User-B would not have sent them the ad unless User-B approves of it. Otherwise, User-B would attach a disapproving or a mocking message with the ad. If User-B attaches an endorsing message, such as the one described above, the receivers would positively know that their friend, User-B, likes the product XYZ in the ad and wants them to review the ad.

FIG. 1B shows a forwarded ad displayed in a hand-held device 100, in accordance with one embodiment of the present invention. The hand-held device 100 is a mobile (or wireless) communication device. For example, hand-held device 100 is Device-1 of FIG. 1A, which belongs to Friend-1. The hand-held device 100 has a display area 110 and a button and key area 120. The display area 110 is a screen that can display text messages, images, and videos. Hand-held device 100 is also capable of playing audio files. The button and key area 120 contains buttons, such as button 121, and keys, such as key 122, for Friend-1 to push. For example, button 121 could be a call button for Device-1, and keys 122 are alphanumeric buttons. Of course, other arrangement and configuration of keys and buttons are also possible.

In the display area 110, there is an endorsing message 111, which is created by User-B. In the lower portion of display area 110, there is a forwarded ad 112, which is MobileAd-1 described above. In the example shown in FIG. 1B, MobileAd-1 is a shoe sale ad for Store-A.

The endorsing message 111 by User-B contains text that tells the receivers of the forwarded ad 112 that User-B loves shoes from Store-A and that the receivers, such as Friend-1, Friend-2, Friend-3, and Friend-4, should check out the sale ad 112. When Friend-1 sees the display area 110 of Device-1, Friend-1 sees the endorsing message 111 and the forwarded ad 112. The forwarded ad 112 can include text, which can contain links to other web pages that provide additional information, images, or a video. In the example in FIG. 1B, the MobileAd-1 is a video, which can be played by clicking on a button 113. Friend-1 can decide whether to click on the button 113 to view the ad. The endorsement and forwarding of MobileAd-1 by User-B would increase the likelihood ad would be viewed by Friend-1.

The system could analyze the user profile of User-B to determine other mobile device users that User-B knows and possibly could be interested in certain types of ads. The user profile of a user, such as User-B, can include spatial (geographical location), social (relationships with other people), temporal (related to time or event), and topical (related to topics or interests) information of the users. For example, User-B lives in San Francisco, and is a 30 year-old female professional. User-B also likes jazz music, plays guitar, and likes to travel. Based on the user profile of the User-B, User-B would be associated with a number of people through her job, her residence, and her hobbies, etc. The user profile of User-B allows certain ads to be targeted. The user profiles of people that User-B knows can also be analyzed to determine which ads should be targeted to individuals that user-B knows.

User profiles can be based on users' inputs. For example, when a user signs up for a mobile service, the user might enter certain personal information (profile), such as age, sex, income level, education level, and address, etc., during registration. In addition to users' entered information, information about users can be retrieve from other sources. For example, other sources may include the Internet, a communication network that stores information about individuals, actual communication, such as emails, Instant Messaging, and phone conversation, transaction, web-surfing data, search histories, ad interaction data, available online behavior analytics, and personal published data, such as data published on social networking sites, blogs, or web sites.

FIG. 1C illustrates an exemplary model of a communication network, in accordance with one embodiment of the present invention. The communication network shown in FIG. 1C is a “W4 Communications Network” or W4 COMN 130, that uses information related to the “Who, What, When and Where” of interactions with the network to provide improved services to the network's users. The W4 COMN is a collection of users, devices and processes that foster both synchronous and asynchronous communications between users and their proxies. It includes an instrumented network of sensors providing data recognition and collection in real-world environments about any subject, location, user or combination thereof.

The W4 COMN uses a data modeling strategy for creating profiles for not only users and locations but also any device on the network and any kind of user-defined data with user-specified conditions from a rich set of possibilities. Using Social, Spatial, Temporal and Logical data available about a specific user, topic or logical data object, every entity known to the W4 COMN can be mapped and represented against all other known entities and data objects in order to create both a micro graph for every entity as well as a global graph that interrelates all known entities against each other and their attributed relations.

As shown in FIG. 1C, W4 COMN 130 includes a Who Cloud 132, a Where cloud 134, a When cloud 136, a What cloud 138, and a W4 engine 135. W4 COMN 130 creates an instrumented messaging infrastructure in the form of a global logical network cloud conceptually sub-divided into networked-clouds for each of the 4Ws: Who (Who cloud 132), Where (Where cloud 134), What (What cloud 138), and When (When cloud 136). Who cloud 132 includes all users, whether acting as senders, receivers, data points or confirmation/certification sources as well as user proxies in the forms of user-program processes, devices, agents, calendars, etc. Where cloud 134 includes all physical locations, events, sensors, or other real world entities associated with a spatial reference point or location. When cloud 136 includes natural temporal events (that is events that are not associated with particular location or person such as days, times, seasons) as well as collective user temporal events (holidays, anniversaries, elections, etc.) and user-defined temporal events (birthdays, smart-timing programs). What cloud 138 includes known data—web or private, commercial or user—accessible to the W4 COMN 130, including for example environmental data like weather and news, real-world-entities-generated data, IOs and IO data, user data, models, processes and applications. Thus, conceptually, most data is contained in the What cloud 138.

W4 engine 135 is a network relationship-tracking engine. W4 engine 135 is center of the W4 COMN's central intelligence for making all decisions in the W4 COMN. An “engine” as referred to herein is meant to describe a software, hardware or firmware (or combinations thereof) system, process or functionality that performs or facilitates the processes, features and/or functions described herein (with or without human interaction or augmentation). One function of W4 engine 135 is to collect data concerning all communications and interactions conducted via W4 COMN 130. Other data collected by the W4 COMN 130 can include information about the status of any given real world entities, such devices, sensors, and cars, etc., and input/output at any given time, such as the location, operational state, monitored conditions and current status. Information about users retrieved from a communication network, such as W4 COMN described above, can provide a lot of information about users without users knowing or actively entering the information. By collecting information about users from different sources, comprehensive user profiles of users of mobile (or wireless) devices can be established.

To match ads with targeted users or owners of mobile devices, the system needs to know the target profiles of the ads, the user profiles of owners (or users) of mobile devices (or mobile devices), and the relationships between these users of wireless devices. A relational understanding of users to other users in the ad distribution and ad-forwarding network is collected. Since the ads are forwarded by individual owners of devices, the network of mobile (or wireless) devices and their owners can be called an “Ads By Me” network. The system that performs such ad forwarding with or without ad endorsing can be called an “Ads By Me” engine. In one embodiment, users' devices would need to be registered to allow users' profiles be matched with targets of ads. Different matching algorithms can be used. For example, histograms or clustering of points on graphs can be used to reveal the best match between ads and users. When a user is sent an ad, a list of other mobile users that the user knows can be also attached to allow the user to forward the ad, with or without endorsement.

FIG. 1D shows an exemplary mobile device, Device-B 125 of User-B, that receives an ad, MobileAd-1 112′ described in FIGS. 1A and 1B, and a list 126 of mobile users that could also be interested in the ad. The list 126 of FIG. 1C shows a number of mobile users, including Friend-1, Friend-2, Friend-3, and Friend-4 of User-B, that could be interested in MobileAd-1 112′. User-B can choose to forward MobileAd-1 112′ to some, all, or none of the users in list 126. If User-B decides to forward MobileAd-1 112′ to people on list 126, User-B can make selection by clicking on the boxes, such as box 127, in front of each name or address. Afterwards, User-B can click on a “Forward” button 128 to forward the ad. Alternatively, User-B can also click on an “Endorse & Forward” button 129 to enter endorsing message. Once the MobileAd-1 112′ is forwarded, it appears on a receiver's mobile device in a manner shown in FIG. 1B.

As mentioned above, the system can be set up to record the ad forwarding activity of User-B. The number of users that receive the ad forwarded by User-B can be recorded. In one embodiment, the recording of the ad-forwarding and ad-endorsing activities can be stored in the mobile devices that execute the forwarding and endorsing activities. The mobile device can then exchange recorded activities with a central payment system for different advertisers or to a payment system of an individual advertiser to get reward. As mentioned above, rewards for forwarding and endorsing ads can be monetary or points that can be used to obtain goods and/or services. Alternatively, the recording of the ad-forwarding and ad-endorsing activities can e stored in a central system. The central system can be part of the payment (or reward) system or can communicate with the payment (or reward) system.

The advertisers can use such data to track the effectiveness of their ad campaigns by analyzing the data of the forwarding and endorsing activities and sales. The advertisers can also use such data to reward forwarders/endorsers. Rewards provide additional incentives for users to forward and/or to endorse (or to promote) the ads of products and/or services they appreciate. As mentioned above, receiving ads from known people with or without endorsement increases the likelihood the ads being viewed.

FIGS. 1A, 1B, and 1D described above show examples of how ads being received and forwarded with or without endorsements. In one embodiment, when a user is interested in making a financial gain by forwarding and/or endorsing ads, a user needs to sign up for the “Ads By Me” service. The system takes the request from a user (to join the “Ads By Me” service), and then verifies the identities of the user and the user's mobile device. In one embodiment, the system then validates and tests the capability and performance of the user's mobile device. For example, the system can pin the user's device to if there is any discrepancies between what the user claims about the capability and performance of the device and the capability and performance of the device. The validation and testing allows the system to determine the device bandwidth, capability and strength of the user's mobile device to determine whether the user's device is suitable for ad-forwarding and ad-endorsing. In one embodiment, the “Ads By Me” service can allow or decline the user based on the capability and performance of the user's device.

In one embodiment, after the user's device passes the test, the user profile of the user is then gathered as discussed above. In one embodiment, based on the user profile of the user, the “Ads By Me” service determines whether the user is a good ad-forwarder and/or ad-endorser or not. For example, users who do not have an extensive social network might not be suitable to be ad-forwarders and/or ad-endorsers. However, the criteria could be based on the types of ads being promoted. For example, some ads are only targeted to some specific types of people, who might not have extensive social network, but they might know the right people for the ad. In this case, the size and extent of social network along is not enough to determine if a user is a good candidate for ad-distribution and ad-endorsing.

FIG. 1E shows a process flow 140 of forwarding (or distributing) a received ad by a user, in accordance with one embodiment of the present invention. At operation 141, ads and their corresponding targets (or ad targets) are received and stored in one or more databases. At operation 142, the registrations of mobile ad serving devices are received and stored. In one embodiment, users consciously register to distribute ads. Users can be motivated by money or other forms of rewards. In another embodiment, the registration is automated when users sign up for service of the mobile devices. In such case, users do not actively register to become ad distributors. In this case, users automatically become potential ad distributors. However, users can still choose not to participate in ad distribution by not forwarding and/or endorsing the ads.

The mobile devices are associated with their users. At operation 143, user profiles of the registered device owners (or users) are retrieved. As discussed above, user profiles can be entered by the users and also can be retrieved from different sources. At operation 144, match ad targets with user profiles to generate ad inventories and ad-forwarding lists for registered mobile ad serving devices. For example, an ad could be matched to a number of users whose profiles indicate that they are targeted by the ad. Multiple ads could be matched to user profile of user of a particular mobile ad-serving device. The analysis may also reveal the people (also device owners) who are socially related to the users targeted by a particular ad. Such people could be indirectly targeted by the ad due to weaker matching between ad targets and user profiles. However, the knowledge and the relationship between them and the targeted users could turn them into potential customers as a result of the promotion by the targeted users.

At operation 145, ads are sent to mobile ad serving devices matched by ad targets. In one embodiment, each delivered ad is accompanied by a list of people who the owner of the receiving mobile device knows and who could be interested in the ad. The information is delivered to the receiver's device in a manner that is easy for the receiver to forward with or without endorsement to the people on the list. After viewing the received ads, owners (or users) of the mobile ad serving devices determine whether to forward ads to other users at operation 146. If the owners of the mobile ad serving devices decide to forward ads, they then forward the ads to users on ad-forwarding lists 147. As mentioned above, the ads can be forwarded with or without endorsement. The people they forward the ads could be on or off the list. If the owners decide not to forward the ads, the process stops.

The example shown in FIG. 1A describes the receivers, such as Friend-1, Friend-2, Friend-3, and Friend-4 of FIG. 1A, of the forwarded ad as being physically away from the ad endorser, User-B. Alternatively, the advertisement can be forwarded or sent to people in the vicinity by using wireless protocol for exchanging data over short distances from fixed and mobile devices, such as Blue Tooth or WiFi. In one example, a tofu vendor, Vendor-A, in a rural area of China brings freshly made tofu to various markets in the area to sell. Vendor-A sells tofu at various markets on an irregular basis, depending on how Vendor-A perceives the need of his/her customers. For example, if Vendor-A visits Market-1 and finds that not many shoppers in Market-1 are interested in his/her tofu at that time, Vendor-A would bring the unsold tofu to another market, Market-2. Vendor-A wants to sell all, or most, of the freshly made tofu in his/her possession to avoid the tofu from becoming spoiled. Vendor-A can stand in a corner of Market-1 or Market-2 and wait for customers. The people who frequently shop for Vendor-A's tofu might or might not know Vendor-A is in the market near them. If Vendor-A can send out a mobile message to let his old customers know where Vendor-A is, it would help Vendor-A connect with his/her customers and can help the sale of Vendor-A's tofu. Wireless protocol can be applied when Vendor-A sends out the mobile message.

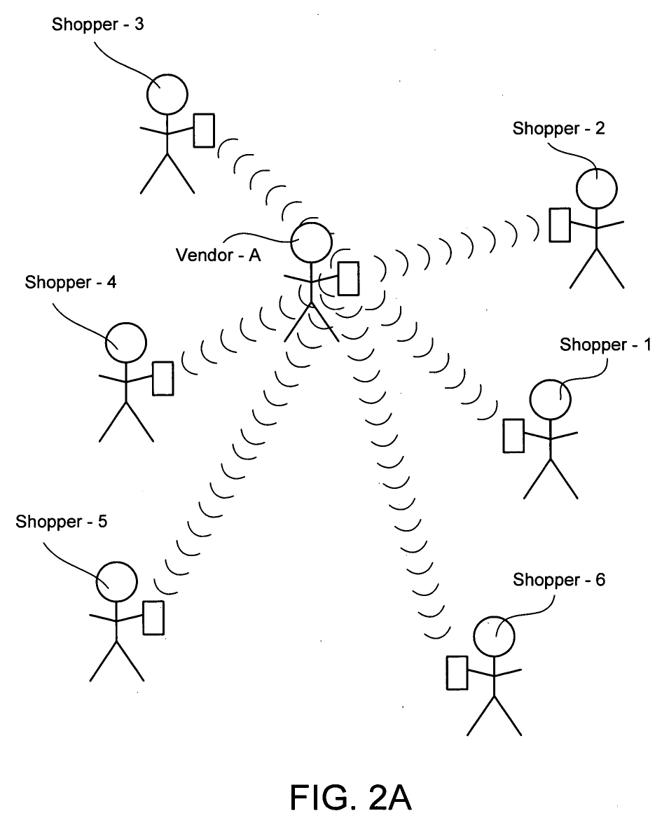

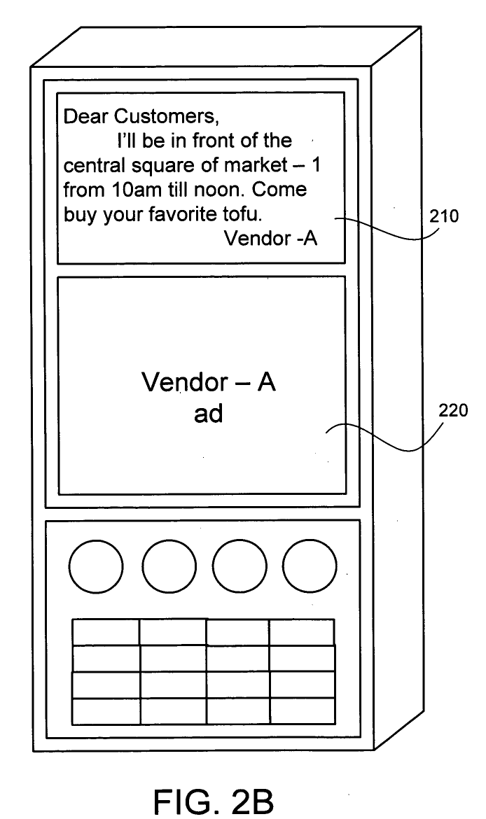

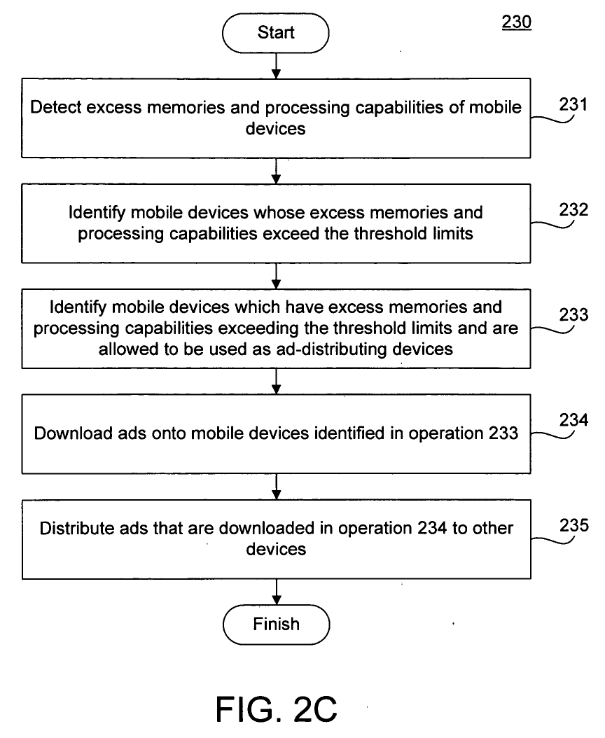

FIG. 2A shows Vendor-A sending out a message or an ad to past customers in his/her vicinity, in accordance with one embodiment of the present invention. As explained above, Vendor-A is in Market-1, where there are many shoppers. Vendor-A sends out a message to let shoppers around Market-i that he/she is in Market-i selling fresh tofu. Shopper-1, Shopper-2, Shopper-3, Shopper-4, Shopper-5, and Shopper-6 are past customers of Vendor-A. Vendor-A's message is sent to them, who all carry mobile devices.

FIG. 2B shows the message (or ad) that Vendor-A sends to his customers, in accordance with one embodiment of the present invention. Vendor-A's message, which is an ad shown in area 210, lets the past customers of his/her in Market-1 know that Vendor-A is “in front of the Central Square of Market-1” (location) from 10 am till noon (time), and requests that they come by and purchase tofu. Mobile devices allow Vendor-A's message (can be seen as an ad) to reach his/her potential customers. If they want tofu today, they could come see Vendor-A in front of the Central Square. Alternatively, Vendor-A could have created an ad ahead of time and forward the ad with the time and location described above. FIG. 2B shows the Vendor-A's ad in area 220. The ad in area 220 would likely describe the product and Vendor-A to help customers remember who Vendor-A is and the product provided by Vendor-A. One of Vendor-A's customers, after receiving the ad, can decide to forward the ad to his/her acquaintance to inform them that Vendor-A is in the market. He/she can do so by forwarding the ad with or without endorsement. The ad would be distributed to people who could be interested in the product (tofu) that Vendor-A is selling.

Similar to the situation described in FIGS. 1A and 1B, the ad-distribution system can be set up to record or track the ad forwarding activity of Vendor-A. The number of users that Vendor-A forwards the ad to can be recorded. Vendor-A can use such data to determine how many customers he has reached over a period of time. The ad-forwarding system and method are configured to assist vendors, such as Vendor-A, to easily send their ads to their customers. In one embodiment, the ad-distribution system has ad-creating tools available to users, such as Vendor-A, who want to promote their products and/or services. The ad-creating tools assist users in generating ads to promote their products and/or services. For example, the tools could include icons, text (such as examples of advertising messages), audios, and videos for users, such as Vendor-A, to create an ad. Alternatively, Vendor-A can also make a simple video by using his/her cell phone as an ad, without using the ad-creating tools. The system is set up to allow users, such as Vendor-A, to upload the ads created by them.

As mentioned above, the system and method described above are particularly useful to mobile device users in the rural areas. In the example described above, Vendor-A, actively distributes the ad. Alternatively, ads can be loaded onto users' cell phones or other types of mobile devices without the users' knowledge. The mobile devices of these users become ad-distributing devices (or servers) without the users' knowledge. As described above, with the advancement of technology, mobile devices, such as cell phones, are built with excess processing power and memories that many ordinary users do not need. The excess processing power and memories of these mobile devices can be harvested and utilized by advertisers in cooperation with the mobile service providers to distribute ads. The mobile service provider(s) may detect the excess memory and processing power (or capacities) of mobile devices of some users. In one embodiment, ads are then downloaded onto these mobile devices without the users' knowledge or per agreement. In one embodiment, ads are downloaded onto mobile devices with excess memories and processing capacities exceeding certain thresholds. Mobile devices need to have sufficient excess memory and processing capacities to be selected as ad-distributing (or ad-serving) devices. These mobile devices become mobile ad-distributing servers. In one embodiment, the ads on these mobile devices can be sent to other mobile device users around the users or near the users, such as in the same city. Alternatively, ads on these mobile devices can be sent to ad-display systems in public places, such as restaurants, buses, trains, and public squares. In one embodiment, new ads can be loaded onto the selected mobile devices, which have sufficient excess memories and processing capacities, to replace the old ads.

By using the excess capacities of mobile devices, the need for centralized ad storages and processing capacities can be greatly reduced. When users' mobile devices are utilized to distribute ads without users' knowledge, legal issues need to be considered and solved before such method and system are put into practice. For example, the mobile service providers might need to obtain users' signed waver forms, which permit such usage. In one embodiment, the mobile service providers provide financial incentives for users who allow such usage of their mobile devices.

FIG. 2C shows a process flow 230 of identifying mobile devices as ad-distributing devices, in accordance with one embodiment of the current application. At operation 231, the excess memories and processing capabilities of mobile devices are detected by a system in communication with the mobile devices. The system can be a system owned by the company that the users of the mobile devices subscribe mobile services. At operation 232, the excess memories and processing capacities of mobile devices are compared again threshold limits to identify mobile devices whose excess memories and processing capacities meet the requirement. At operation 233, mobile devices that exceed the threshold limits are compared against a list of mobile devices that can be used as ad-distributing devices to identify mobile devices that can be used as ad-distributing devices. For example, the list of mobile devices contains mobile devices whose owners have signed the usage waver forms or has signed up to participate in ad distribution.

At operation 234, ads are downloaded onto the mobile devices that are identified (selected) as ad-distributing devices. In one embodiment, the types of ads are downloaded on the mobile devices are based on the profiles of the owners of the mobile devices. For example, if the owner of the mobile device regularly takes subway, the ads downloaded to the mobile device can be tailored to be displayed on ad-display systems on subways. At operation 235, ads are sent (or distributed) from these selected mobile devices to other devices, such as other mobile devices or wireless ad-displaying systems.

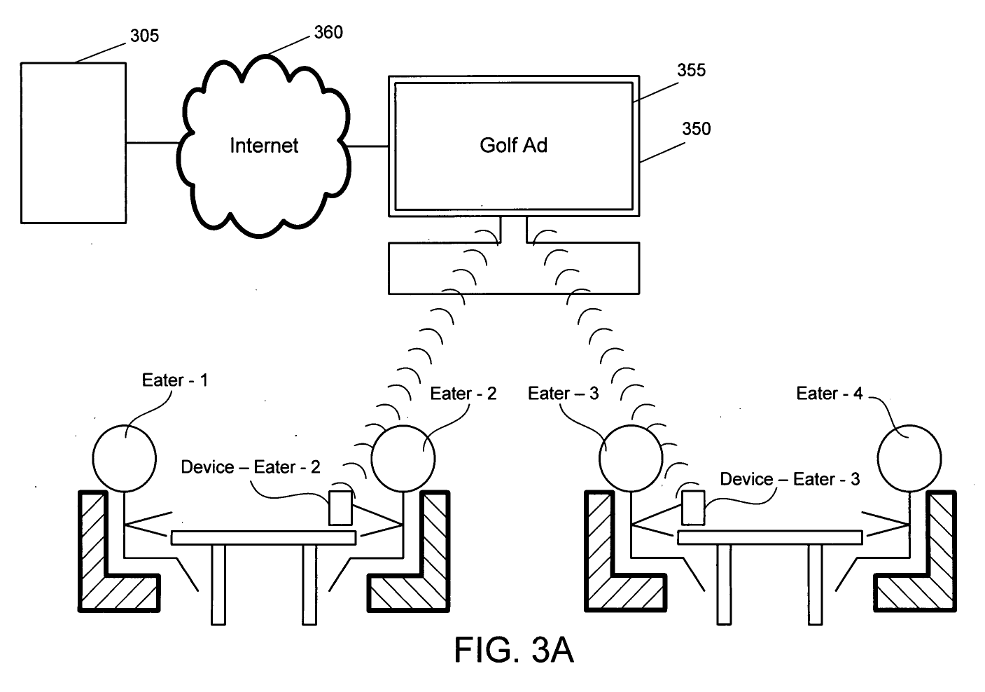

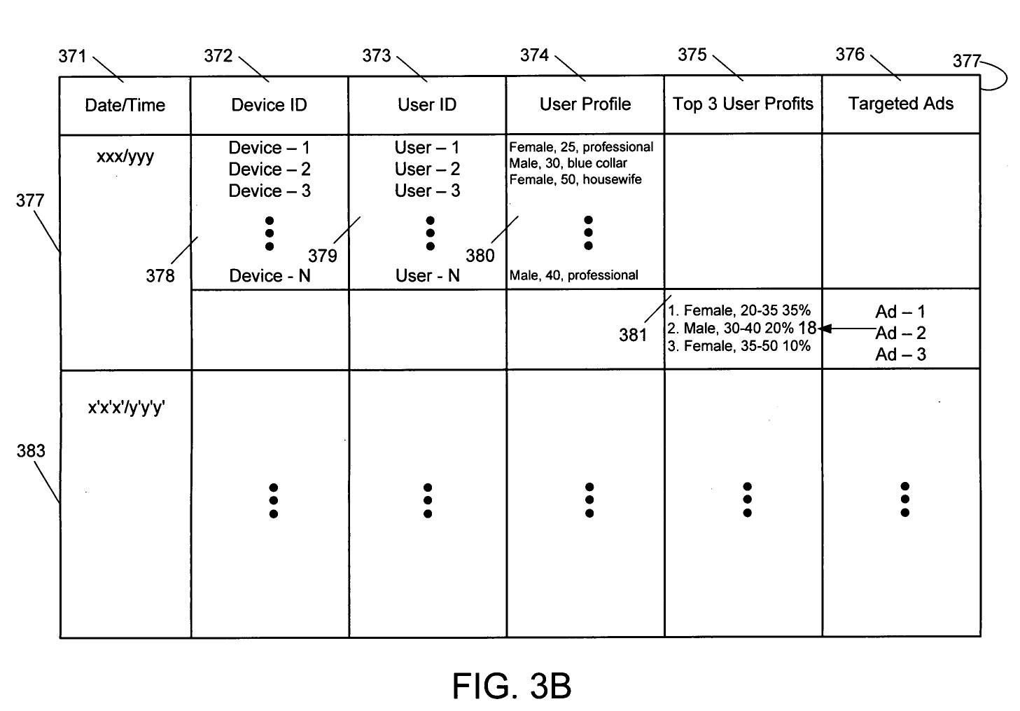

In the examples described above in FIGS. 1A, 1B, 2A, and 2B, ads are consciously sent to targeted receivers. The sender of the ad knows who the receivers are. Alternatively, the sending and/or forwarding of the ad can be done by a system(s), which determines which ads to send to the receivers. FIG. 3A shows an ad 355 displayed on a display unit 350 in a restaurant, in accordance with one embodiment of the current invention. In the restaurant, there are a number of customers, including Eater-1, Eater-2, Eater-3, and Eater-4. Eater-2 and Eater-3 both carry mobile devices, which transmit wireless signals to the display unit 350. The display unit 350 can be any device that can receive ads, receive signal from mobile devices in the vicinity and can display ads. For example, the display unit 350 can be a flat screen television or any display. The mobile devices of Eater-2 and Eater-3, Device-Eater-2 and Device-Eater-3, emit signals to the display unit 350. The signals sent by the mobile devices of Eater-2 and Eater-3 provide information that helps to identify the mobile devices of Eater-2 and Eater-3. Such signals are then sent by the display unit 350 to a user profile system 365, which stores the user profiles of different mobile device users. In one embodiment, the display unit 350 accesses the user profile system 365 via Internet 160. In another, the display unit 350 is connected to the user profile system 365. In yet another embodiment, a database of user profile is stored in the display unit 350.

In the example shown in FIG. 3A, the user profile system 365 identifies Eater-2 and Eater-3, using the signals emitted by Device-Eater-2 and Device-Eater-3, as avid golfers. The display unit 350 stores numerous ads or can fetch ads from an external source. Upon determining that Eater-2 and Eater-3 in the restaurant are avid golfers by their user profiles, the display unit 350 would select or fetch a golf ad that would appeal to Eater-2 and Eater-3. In this example, the display unit 350 is configured to display ads that are relevant and appealing to people in the restaurant. The ads displayed are targeted using the user profile associated with the mobile devices carried by the users. In one embodiment, the ads displayed on display unit 350 can be prioritized based on the number of people with matched user profile. For example, the ad that appeals to 3 customers will be displayed before the ad that appeals to 1 or 2 customers.

Ad-displaying units, such as display unit 350, are becoming more popular in public places, such as restaurants, public squares, gas stations, and theaters. Large flat screen televisions and/or monitors can be used to display advertisement. Vendors place them in public places to display ads. Such ad-displaying devices become part of an outdoor display advertising network (ODDAN). Currently displaying ads on such systems are pre-programmed. For example, many gas stations have TV monitors near gas pumps displaying ads and/or program for customers to view while they are getting gasoline. However, with the embodiments described in the current application, the ads displayed on such units can be modified or arranged based on the audience surrounding the display units. In the example described above, the display unit 350 senses Eater-2 and Eater-3 and receives (or retrieves) their profiles to know that these two people like to golf. As a result, a golf-related ad, such as an ad selling golfing equipment or an ad about a golf course, is played or displayed on display unit 350. If there are other eaters in the restaurant of FIG. 3A that share a common user profile or interest, a different ad that suits such a profile or interest can be aired (or displayed) on display unit 350 before or after the golf ad.

Similarly, an outdoor display unit at a public square can sense a number of mobile devices (being carried by people) are present near the square. The profiles of the owners of the sensed mobile devices can be retrieved to determine common profiles and interests to determine one or more ads to be displayed to the crowd near the public square. The ad-displaying algorithm can be configured as selecting ads to target the dominant crowd population. For example, if the majority of the crowd comprises of women at an age range between 18-35, one or more ads related to be women's apparel could be aired at the display unit. Alternatively, the displaying algorithm can be configured to find the top three majority of the crowd and to select ads to display to these top 3 groups of majorities in sequence. Different algorithms can be used to suit different locations. Since the crowd changes with date and time, the algorithm can also be set up to change with date and time. Based on the algorithm, a continuous flow of advertisements can be displayed to the crowd in the public square.

As described above, the ads that are targeted to the crowd in a public place based on user profiles can be determined by a system, such as system 350 or 365 discussed above. System 350 or 365 may store data of mobile devices detected in the vicinity of the public place. In one embodiment, the system correlates users (or owners) to the mobile devices detected and also retrieves the user profiles of the device users. In one embodiment, the system can further determine one or more dominant profiles of the crowd, which can be used to determine the ads that are displayed to the crowd. FIG. 3B shows a table 370 of ad targeting of a crowd, in accordance with one embodiment of the current application. In this embodiment, the crowd is in front of a local public square, which has a large ad-display board. The ad-display board has a sensor(s) that can detect signals sent by mobile devices to know the identification of the devices.

Table 370 has a column 371 of date and time of the crowd data collection, a column 372 of mobile device identification, a column 373 of user identification, and a user profile column 374. The information in the user identification column 373, and the user profile column 374 are retrieved (from one or more data sources) using the device identification information in column 372. FIG. 3B shows that in area 377, the date and time of the data collection are “xxx” and “yyy” respectively. Area 378 under column 372 lists a number of device identifications collected by the sensor. Area 379 lists a number of user identifications corresponding to the device identifications. Area 380 lists a number of user profiles corresponding to the user identification in column 374. For example, the user profile of User-1 lists User-1 being female, 25 years old, a professional, and etc.

After a processor analyzes the data in the user profile column 374, top few, such as 3, crowd profiles are listed in area 381 of column 375. In the example shown in FIG. 3B, the top crowd profile is “female” with age between “20-35” at a crowd percentage of 35%. The second group is “male” with age between ’30-40” at a crowd percentage of 20% (or 20% of people with mobile devices in the public square). The third group is “female” with age between “36-50” at 10% of crowd percentage. Once the top population groups are identified, the system is configured to select ads that are targeted at the top profiles of the crowd. The profiles listed in area 381 of FIG. 3B are merely examples. Other types and categories of user profiles can be used. In the example of FIG. 3B, area 382 of column 376 shows 3 ads that correlates to 3 top crowd profiles. Ad-1 suits group 1, Ad-2 suits group 2, and Ad-3 suits group 3. In one embodiment, the ad-display board displays these ads in sequence to the crowd in the public square. Alternatively, the system can select two or more ads for group 1 and show more ads to the dominant group. Other ad selection and displaying algorithms can also be used.

While the ads are being displayed, the system can continue collecting and analyzing crowd profile to make the best selection of ads to be displayed to the crowd at next display time slots. The ad selection and display can be targeted to the crowd in real time. For example, area 383 shows another data collection time slot with date and time being “x′x′x′” and “y′y′y′” respectively. Data similar to those described above in areas 378, 379, 380, 381, and 382 can be collected to the new time slot x′x′x′/y′y′y′. The information can be stored to calculate and improve the ad-targeting accuracy and efficiency of the ad-display board. The merchant that sets up such ad-display board can use such data to charge the advertisers. For example, the advertisers can be charged based on how many potential customers the ads have targeted.

Alternatively, the ad displaying systems, such as system 350, can be used to transmit ads to users in the vicinity based on their profiles, instead of displaying ads to them. For example, system 350 can transmit golf-related ads to Eater-2 and Eater-3's devices. Eater-2 and Eater-3 can view the ads on their mobile devices. Further, Eater-2 and Eater-3 could forward such ads to their friends or acquaintance.

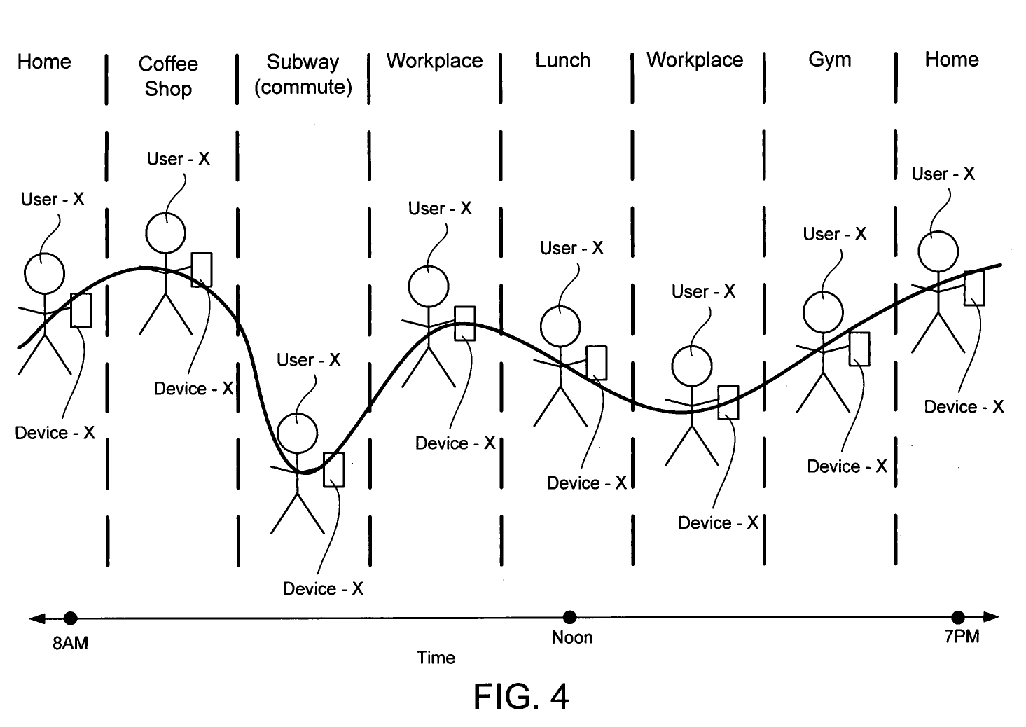

The examples above describe various situations that ads can be forwarded with or without endorsement, and be sent to targeted customers via mobile devices. Their owners typically carry mobile devices whenever and wherever they go. As described above, such devices can be used as ad-forwarding devices and can also be used as ad-receiving devices. As a person goes through his/her daily life, the person can send and/or receive mobile ads throughout the day. FIG. 4 shows a person going through his/her daily activities with his/her mobile device, in accordance with one embodiment of the present application. In FIG. 4, User-X carries his/her mobile device, Device-X, and goes through different daily activities. At 8 am in the morning, User-X is at home. Use-X soon leaves his/her home and visits a coffee shop to get morning coffee. Afterwards, User-X takes a subway to User-X's work place. After working a few hours, User-X then has lunch at a lunch place at noon. Following lunch, User-X returns to his/her work place again to do more work. After work, User-X goes to a local gym to get some exercise, before he/she goes home at 7 pm in the evening.

From FIG. 4, it can be seen that User-X visits different places throughout the day. While User-X is at different places and different time through out the day, User-X can receive and send ads through User-X's mobile device, Device-X. In addition, ads can be displayed on ad-display systems in public places that User-X visits. For example, when User-X is at public places, such as the coffee shop, subway, lunch places, and gym, User-X could view ads displayed on the ad-display systems in these places. As mentioned above, the ad-display systems could also transmit (or download) ads to User-X's mobile device, Device-X. User-X, upon receiving these ads, can decide whether to forward and/or endorse the received ads to his/her acquaintance or to people around him/her through short distance wireless transmission. The ads that are displayed to User-X or downloaded to Device-X through the ad-display systems in the public places or other ad servers are targeted to User-X based on User-X's profile. Since the ads are targeted based on User-X's profile, User-X is more likely to view them. Depending on User-X's affinity for the ads, User-X can decide whether to forward and/or endorse the ads or not.

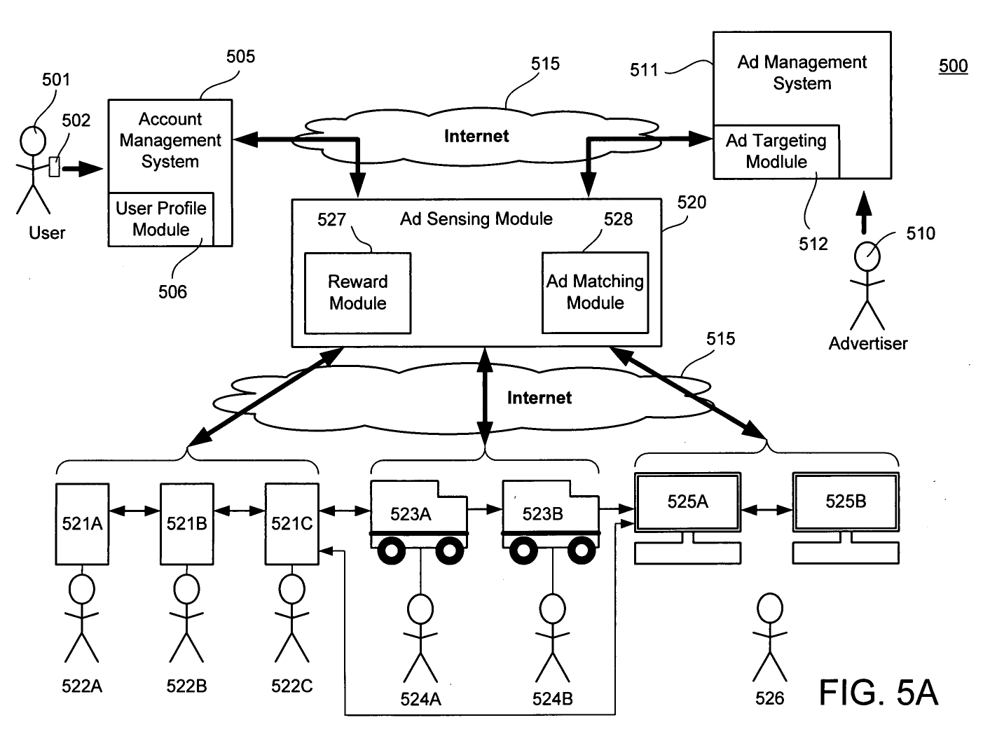

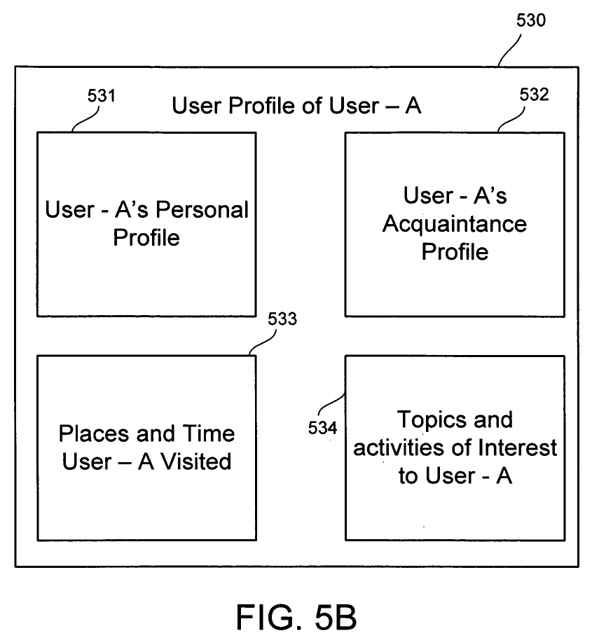

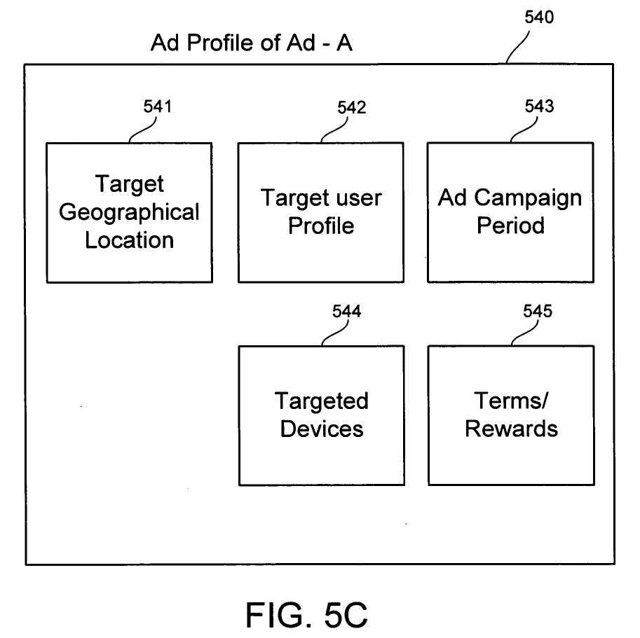

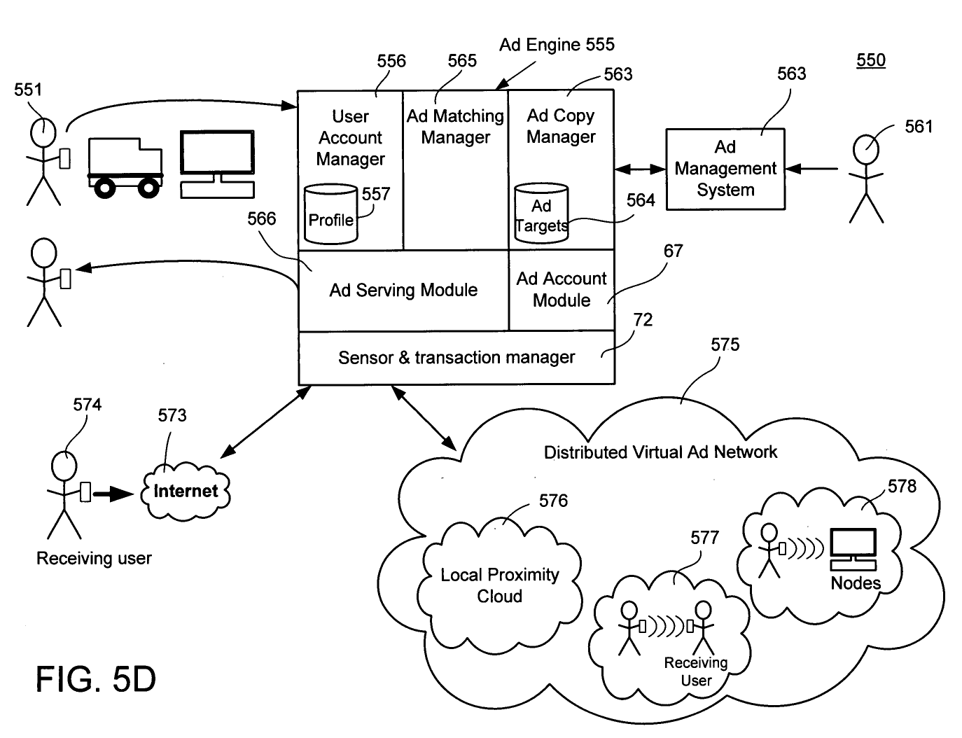

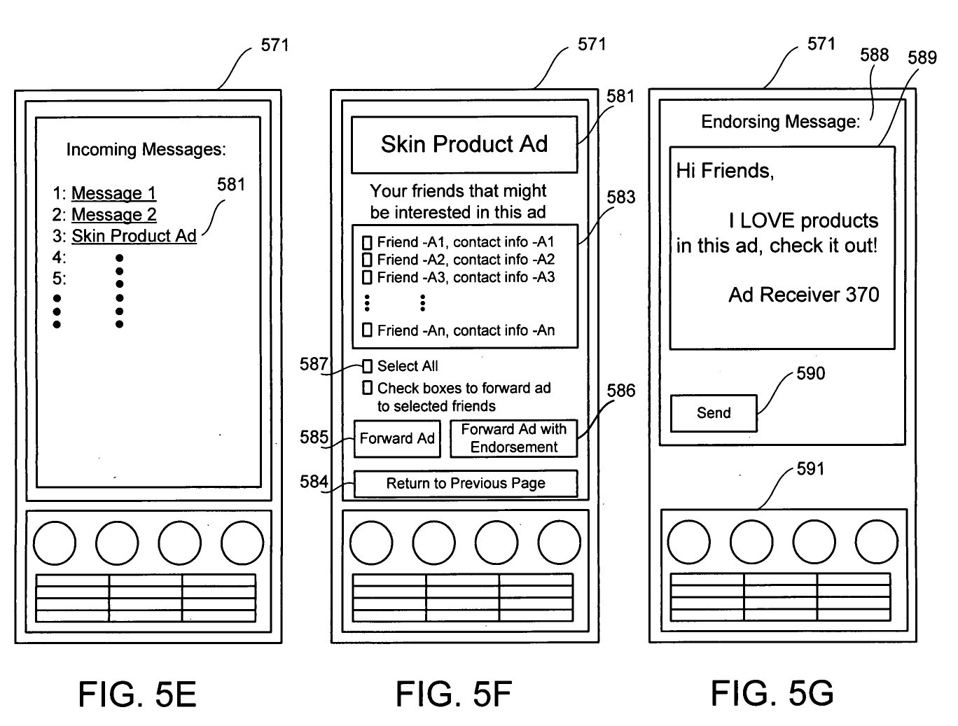

The description above provides various embodiments of distributing and forwarding ads to targeted users. FIG. 5A shows a system 500 for distributing ads, in accordance with one embodiment of the present invention. FIG. 5A shows a user 501 with a wireless device 502. The device 502 is connected through wireless connection or a combination of wired and wireless connection to an account management system 505. The account management system 505 includes a user profile module 506, which stores the user profiles of user 501 and other users, and device identifications of devices 302 of user 501 and other users. The examples of information stored in the user profile module 506 include users' geographical location, such as cities and states of residence, users' age, users' gender, users' income level, users' web shopping histories, users' friends and acquaintance, such as their names, email address and/or cell phone numbers. When user 510 interacts with device 502, the activities are recorded by the account management system 505. For example, if user 501 makes a call or views a web page on the mobile device, the number called and/or web page reviewed would be recorded by system 505. Further, user 501 can also actively enter his/her profile information into the account management system 505. For example, user 501 can enter user profile information through a web page of a web site, which is coupled to account management system 505. Alternatively, user profile can also be obtained from a communication network, such as W4 COMN described in FIG. 1C. In addition, the account management system 505 also handles the registration and screening of wireless devices to be used as ad-forwarding and ad-endorsing wireless devices.

FIG. 5A also shows an advertiser 510 interacting with an ad management system 511. The advertiser 510 can push ads to the ad management system 511, which stores ads from advertisers. In addition, the ad management system 511 has an ad targeting module 512, which stores the groups/types (or profiles) of users that the ads are targeting. In one embodiment, the groups (or types) of users being targeted can be described by terms similar to those used in user profile module 506. For example, the ads can be targeted to females at a certain age range, which is also a user profile. Such ad targeting information (or profile) can be entered by advertisers, such as advertiser 510. Alternatively, the ad targeting profiles can also be modified from responses of ad receivers. For example, if after the ads are sent out to females at the age range from 15 to 50, the response data shows that more particularly females at the age range from 40 to 50 respond to this ad, the ad targeting profile of the ad can be modified to “females at the age range from 40 to 50.”

In one embodiment, the information in the account management system 505 and ad management system 511 are used by an ad serving module 520 configured to deliver ads to various mobile and/or wireless devices, such as hand-held mobile devices 521A, 521B, 521C, wireless devices 523A, 523B in vehicles, and wireless display systems 525A, 525B. Examples of hand-held mobile devices include cell phones and PDAs and they are held by users 522A, 522B, 522C, who carry them around for their daily activities. Some vehicles now have on-board wireless systems that can receive and display messages, ads, videos, audios, and news. Wireless devices 523A, 523B in vehicles refer to such on-board wireless system and are controlled by users 524A, 524B. The wireless display systems 525A, 525B have been described above and are managed by owner 526. Owner 526 could be a merchant who places the wireless display systems 325A, 325B in public places. User 501 can be one of the users 522A, 522B, and 522C. The limited numbers of mobile devices, wireless devices, and wireless display systems, and their owners shown in FIG. 2 are merely examples. There could be more or less devices and owners.

The ad-serving module can access the user and user profile information in the account management system 505 and also the ad and ad targeting (or profile) information in the ad management system 511. The ad-serving module 520 matches the ads in the ad management system 511 to find its targeted users in the account management system 505. In one embodiment, the ad-serving module 520 has an ad-matching module 528 performing the ad matching function. The matching utilizes the profiles that the ads are targeting and the user profiles of users to match ads with targeted users. The matched ads are then delivered to the targeted users. The receivers of these ads can further forward the ads to other users (and other mobile and wireless devices) with or without obvious endorsement. The ad forwarding or sending can occur among hand-held devices or with other types of wireless devices. As mentioned above, when a user 522C is in a restaurant, user 522C's presence could affect the wireless display system, such as 525B, in the restaurant. Also as discussed above, mobile and wireless devices, such as 521A, 521B, 521C, 523A, 523B, 525A, and 525B can act as ad servers and distribute ads to other devices.

The ad forwarding activities can be sent to the ad-serving module to be recorded. In one embodiment, the ad-serving module 520 has a reward module 527, which records the ad forwarding/sending activities and calculates the reward for users. In one embodiment, the reward module 527 also manages the delivery of the reward to the deserving users. The reward could be monetary, or could be coupons, or could be accumulation of points, which can be redeemed on online stores.

The interaction among different devices, such as device 502, 521A, 521B, 521C, 523A, 523B, 525A, and 525B, and systems, such as system 505, 511, and 520, of FIG. 5A can rely completely with wireless connection (No Cloud). Alternatively, the interaction can occur with help of Internet 515 (or Internet Cloud), as shown in FIG. 5A. In another embodiment, the interaction among different devices and systems of FIG. 5A can occur with a combination of wireless and Internet (Partial Cloud).

FIG. 5B shows a user profile 530 of a wireless or mobile device user, User-A, in accordance with one embodiment of the present invention. The profile of User-A 530 includes User-A's personal profile 531, which could include age, gender, income level, geographical location, and etc. of User-A. The profile of User-A also includes a list and of wireless device users that User-A knows and interacts with and possibly includes their profiles. Alternatively, the profiles of these users are stored somewhere else and can be retrieved. Information regarding wireless device users that User-A knows is stored in User-A's acquaintance profile 532. The device identification information of User-A's acquaintance can also be stored in User-A acquaintance profile 532 to allow retrieving. In one embodiment, the profile of User-A 530 also includes the places and time User-A travels (or visits) 533. For example, if User-A is carrying a cell phone, the cell phone can track the key places and time that User-A visits. For example, such tracking could reveal that User-A likes to visit coffee shops, gyms, and bookshops. Such information of User-A could help identify ads that are targeted to User-A and also could affect which ad being delivered to User-A during a particular time. For example if the ad-delivering system 520 described above is aware of User-A being in a shopping mall at lunch hour, the ad-delivering system 520 can identify an ad related to a store in the shopping that User-A frequently visits and send the ad to User-A while User-A is in the shopping mall.

In one embodiment, the profile of User-A 530 may further include topics and activities of interest to User-A 534. For example, names of stores that User-A likes to shop or restaurants that User-A likes to visit can be included. Information related to topics and activities of interests to User-A is very relevant when the ad-delivering system 520 determines (or identifies) ads of interests to User-A. Alternatively, User-A can enter information of his/her interest himself/herself. Otherwise, the system can collect such information from User-A's mobile devices or other information sources, such as W4 COMN described above. The profile of User-A 530 and profiles of other users can be stored in the user profile module 506 of FIG. 5A. When User-A receives an ad, the system 506 can possibly provide a list of User-A's acquaintance that could be interested in the received ad to User-A for User-A to forward the receive ad.

FIG. 5C shows an ad profile (or ad targeting) 540 of an ad, in accordance with one embodiment of the present invention. The profile of Ad-A 540 may include Ad-A's target geographical location 541. For example, if Ad-A is for a local area, the target geographical location 341 is the particular local area, such as the city of San Francisco. Alternatively, the target geographical location can be entire United States. The profile of Ad-A 540 may also include targeted user profile 541. For example, Ad-A may be a cosmetic ad that is targeted toward women between 35 to 50 years of age. The profile of Ad-A 540 may also include an ad campaign period 343. Normally each ad has a campaign period, during which the ad is actively promoted. For example, Ad-A, which is a cosmetic ad, is actively promoted between January 15 to March 15. In one embodiment, ad profile of Ad-A may include targeted devices 544. For example, if Ad-A is a video ad, the mobile device that receives Ad-A must be able to play video. The bandwidth and/or functionality requirement of the device can be specified to ensure Ad-A is delivered to mobile or wireless devices that meet the requirement. Further, Ad-A profile may include terms/rewards 545 associated with Ad-A. Terms and reward 545 defines the condition(s) and reward(s) for the forwarding and/or endorsing Ad-A. For example, advertiser for Ad-A could specify the amount of reward that is available for sending or forwarding the ad. Alternatively, the wireless service company that delivers the ad can specify the reward policy for Ad-A. The company could take out a portion of ad revenue to share with the Users who send or forward Ad-A to their acquaintance.

FIG. 5D shows a system 550 for distributing ads by mobile device users, in accordance with another embodiment of the present invention. FIG. 5D shows a wireless device user 551, who is also a potential ad receiver and/or ad distributor. User 551 could carry a mobile device 552, could be driving a vehicle with a wireless device 553 on board, or could be in charge of a stationary wireless system 554, such as a wireless ad display system discussed above. User 551 accesses the user account manager 556 of an ad engine 555 to register his/her mobile device to register as a wireless device user. In one embodiment, User 551 further registers to allow his/her wireless device to be used as an ad-serving or ad-distributing device. The user account manager 556 has functions and capabilities similar to account management system 505 of FIG. 5A. The user account manager 556 also includes a user profile module 557, which store information related to users. The user profile module 557 is similar to the user profile module 506 of FIG. 5A.

FIG. 5D also shows an advertiser 561 interacting with an ad copy manager 563 through an ad management system 562. The advertiser 561 can push ads to the ad copy manager 563, which can store ads from a number of advertisers. The ad management system 562 can be computer, a server, or a hand-held device. The functions and capabilities of the ad copy manager 563 are similar to the ad management system 511. The ad copy manager 563 also includes an ad-targeting module 564, which stores targeted profiles of ads in the ad copy manager 563. The ad targeting module 564 is similar to the ad targeting module 512 of FIG. 5A.

The information in the user account manager 556 and ad copy manager 563 is used by an ad matching module 565 to determine which ad is best suited to which user. The ad matching module 565 then passes the ad matching information to the ad serving module 566, which manages the delivery of ads to different receivers. The matched ads are sent to wireless devices or systems, such as device 571 of ad receiver 570. In one embodiment, the wireless device or device 571 has a storage 568, which contains personalized ad inventory with ad targets. The personalized ad inventory contains ads that are sent to the ad receiver 570. The ad targets are list of receiving addresses of friends and/or families and/or acquaintance of ad receiver 570 for each corresponding ads in the inventory. In one embodiment, the storage 568 is the same storage for messages for ad receiver 570. In another embodiment, storage 568 is a dedicated database that contains only the personalized ad and corresponding ad targets. In yet another embodiment, the ad targets contain a list of acquaintance of ad receiver 570 and the list is applied to all ads.

For example, if ad receiver 570 is a 40 years-old female and has previous shown interests in skin care products, ad receiver 570 could receive a skin product ad 581 on her mobile device 571, as shown in FIG. 5E. When ad receiver 570 clicks on the skin product ad 581 of FIG. 5E, a page 582 appears on device 571, as shown in FIG. 5F, in accordance with one embodiment of the present invention. FIG. 5F shows the skin product ad 581 and also a message below the ad 581. The message says: “your friends who might also be interested in this ad:” and a list 583 of ad receiver 570's friends with their forwarding email addresses or device access account, such as cell phone numbers. After ad receiver 570 reviews ad 581, ad receiver 570 decides whether she wants to forward ad 581 or not. If ad receiver 570 does not want to forward 5d 381, she can simply click on the “return to previous page” button 584. If ad receiver 570 wants to forward ad 581, she can use the selection box in front of each address to choose acquaintance or friends or her to forward the ad. Alternatively, she can click on the box 587 in front of “select all” to choose all the people on the list 583.

Ad receiver 570 can also click on the “forward ad with endorsement” button 586. A window 588 would open when ad receiver 570 clicks on button 586. FIG. 5G illustrates the window 588 with a field 589 showing a default ad-endorsing message, in accordance with one embodiment of the present invention. However, ad receiver 570 can delete or modify the default ad-endorsing message and types in a message of her own by using keys in area 591 of device 571. Afterwards, ad receiver 570 can push a “send” button 590 to send out the skin product ad 381 with endorsement to her friends.

Returning to FIG. 5D, the ad engine 550 has an ad account manager 567, which records the transaction between the ad engine 550 and the users, such as ad receiver 570, and the forwarding/endorsing of ads between users. Alternatively, the ad account manager 567 is part of the ad-serving module 566. In one embodiment, the ad engine 550 also utilizes a sensor and transaction manager 572 to sense the interaction (or transaction) between mobile/wireless devices and the ad engine 550. The sensor and transaction manager 572 also assists the transaction between users' wireless devices with the ad engine 550. The ad engine 550 can interact with individual users, such as ad receiver 570 directly. Alternatively, the ad engine 550 may interact with receiving users, such as user 574, though the Internet (or Internet cloud) 573. In addition, the ad engine 550 can interact with users in a distributed virtual ad network(s) (or a distributed sense network) 575, as shown in FIG. 5D.

In the example shown in Figure SD, the distributed virtual ad network(s) 575 includes a local proximity cloud 576, where wireless connection is available to a local community and users in the community can receive signals from devices in the community. For example, the local proximity cloud 576 can be a peer-to-peer network or a local network. The distributed virtual ad network(s) 575 may include users forwarding ads to other users in their vicinity 577. Further, the distributed virtual ad network(s) 575 may be users sending or forwarding ads to be displayed in local display nodes in the vicinity 578.

For users to send or forward ads to other users in local proximity cloud, to other users in the users' vicinity, or to display nodes in the users' vicinity, the users' wireless or mobile devices become ad servers for the advertisers. Each mobile or wireless device stores a number of ads and possibly a list of potential targets of the ads. With these mobile or wireless devices, the advertisers gain extra capacities in storing and serving ads.

In one embodiment, ads in the ad engine 350 can be distributed to the mobile or wireless devices with the knowledge of the users. The users sign up to become ad distributors to gain reward in return or just for the fun of it. The advertisers can check out the backgrounds of the users, such as to see if the users have past legal problems or if the users have sufficient connections with other device users. The advertisers may also check out the device capabilities of the users. The advertisers can determine whether to allow the users to become ad distributors or forwarders or not. If the advertisers decide certain users are qualified to be ad distributors, the system, such as ad engine 350, should be set up to track or record participating users' (or ad forwarders') ad forwarding activities. Tracking (or recording) the ad forwarding activities of participants (or users) would help advertisers to know how the ad-campaign is going, and how efficient or how often the participating users are performing the ad forwarding activities. Tracking (or recording) the ad forwarding activities of users also allow advertisers to correctly provide reward to the participating users. As mentioned above, participating users could be motivated by rewards to distribute ads more frequently or actively to more people. As discussed above, the reward can be monetary or be redeemable points that users can exchange for goods and/or services.

In another embodiment, ads in the ad engine 350 can be distributed to the mobile or wireless devices without the knowledge of the users. The advertisers work with the mobile and/or wireless service providers of the users to distribute ads to these mobile and/or wireless devices without the knowledge of the users. The mobile and/or wireless service providers check the capacities of the mobile and/or wireless devices for excess storage capacities. The capacity information is relayed to an ad distribution system, such as ad engine 350. The ad distribution system then distributes a number of ads to each of the wireless devices with excess storage or processing capacities. The number of ads depends on the excess capacity of the mobile or wireless devices. In one embodiment, the ads loaded onto the wireless or mobile devices and forwarding of these ads do not impact the performance of such device, or the performance impact is not obvious to the owners of the devices.

When the users visit different places in the users' daily lives, the users' mobile or wireless devices serve as ad-distributing servers to send ads to other wireless devices known to the users, or devices in the users' vicinity or to local display nodes. For example, such a system and method work effectively to allow ads to be distributed to rural areas, where computer servers or other types storages and processors are limited. The system and method discussed above, where ads are distributed to mobile and/or wireless devices without users' knowledge, allow excess wireless processing capacities and capabilities to be harvested.

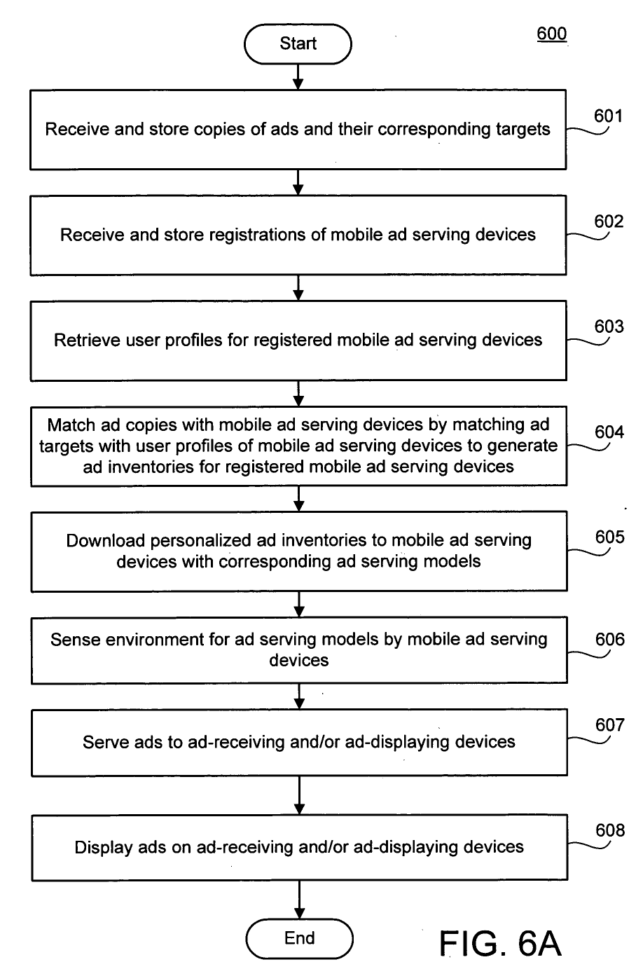

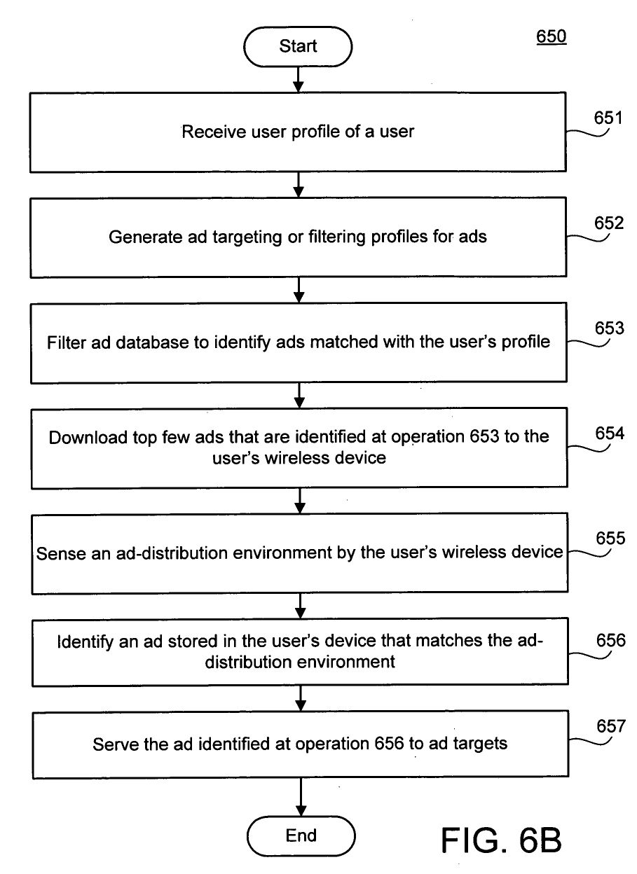

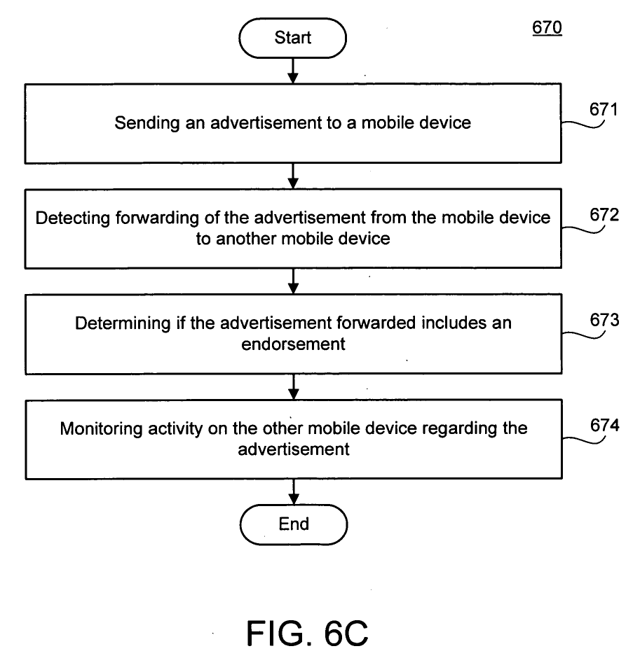

FIG. 6A shows a process flow 600 of receiving and forwarding ads, in accordance with one embodiment of the present invention. At operation 601, ads and their corresponding targets (or targeting goals) are received and stored in one or more databases. In one embodiment, the ads and corresponding targets (or ad targets) are sent by advertisers. At operation 602, the registrations of mobile ad serving devices are received and stored. The mobile devices are associated with users. In one embodiment, the mobile device users knowingly submit applications to participate in ad serving and ad-forwarding. In another, the information of users and their mobile (or wireless) device is collected without the users' knowledge that their devices are being used to serve or forward ads. At operation 603, the association between the registered mobile ad serving devices and the user profiles of the owners (or users) of the registered mobile ad serving devices is retrieved. The association could involve retrieving users' profiles from different databases and networks, such as W4 COMN described above. In one embodiment, the users' profiles also include the users' friends, families, and acquaintance, and their profiles.

At operation 604, the ads and their corresponding targets are matched with the mobile ad serving devices and their corresponding owners (or users) and profiles. The corresponding targets (or target goals) are matched with the user profiles of the device owners to determine which device owner should receive which ad(s). The matching creates a personalized ad inventory for each combination of device and user (or owner). In addition, each ad inventory also includes serving models for different people, places, and time, etc. for the ads in the inventories. For example, a cosmetic ad for women could be most suited to be sent to women at a certain age range at lunch time or after dinner when they are free to view such an ad.

At operation 605, the ad inventories are downloaded to matched mobile ad serving devices with serving models for people, places, and time, etc. At operation 606, ad serving devices sense environment that fit the ad serving models. For example, Device-X of User-X of FIG. 2 maybe on a commuter train at 8:30 am, which has an ad-display system on the wall. The ad inventory of Device-X of User-X has one or more ads targeting morning commuters. The Device-X of User-X senses that the time is 8:30 am (morning) and User-X is on a commuter train near the ad-display system.

At operation 607, the ads that match the targeted goals, such as morning commuters, are served to the targeted devices, such as the ad-display system on the commuter train. At operation 608, the ads that match the targeted goals are displayed to the targeted audience. For example, the ad-display system on the commuter train displays the ads it receives form User-X for the morning commuters to see.

FIG. 6B shows a method 650 of distributing and targeting ads to users, in accordance with one embodiment of the present invention. At operation 651, user profile of a user is received. The user could be one of the many users that have signed up to participate in ad-serving (or ad-forwarding) activities. Alternatively, the user could be one of many users that participate in the ad-serving (or ad-forwarding) activities without knowing. At operation 652, targeting or filtering profiles for ads are generated. The ads could be submitted by different advertisers. Each ad should have a targeted audience. In one embodiment, the targeting or filtering profiles is similar to user profiles of users. The ads and their corresponding targets are stored in database(s). At operation 653, ad database(s) is filtered with the user's profile mentioned in operation 651 to identify ads that match with the user's profile. At operation 654, top few ads that match the user's profile that are identified at operation 653 are downloaded onto the user's wireless or mobile device. The user's wireless or mobile device can be a device operating in a Wi-Fi or Blue Tooth network. In one embodiment, the ads identified at operation 653 are ranked by their relevancy and are placed in order based on their relevancy. The top few of ads are downloaded. Only limited number of ads are downloaded to the user's device due to limited storage space and processing capability. The number of ads downloaded can depend on the available storage capacity and processing capability of the user's device. If the user has a wireless device that has a lot of excess capacities, more ads can be downloaded. In one embodiment, the top few ads are downloaded with serving models. The serving models could include information related to whom, when, and/or where the ads should be sent to or sent. If only one ad matches the user's profile, the single ad would be downloaded onto the user's wireless or mobile device.

At operation 655, an ad-distribution environment is sensed. For example, the user could determine that he/she wants to forward one of the ads after viewing it. This can be considered as an ad-distribution (or serving) environment. Alternatively, the user can be on a morning commuter train at 8:30 and is at a matched ad-distribution (or serving) environment to download an ad to an ad-displaying system on the commuter train, as described above. Afterwards at operation 656, the ad inventory of the user is filtered to identify an ad that best matches the target(s) under the matched ad-distribution environment. For example, the user might have a number of ads for the morning commuter train, and an algorithm could be used to determine (or identify) the best ad to be served. Alternatively, there could be more than one ad that is identified to match the ad-distribution environment. At operation 657, the identified ad(s) is served to the ad targets, which are devices that can receive and display the ad. In one embodiment, the ad is delivered to receiving devices in the vicinity of the user indiscriminately. In another embodiment, the ad is delivered to a list of receivers that matches the ad and the ad-distribution environment.

FIG. 6C shows a method 670 of distributing and targeting ads to users, in accordance with one embodiment of the present invention. At operation 671, a server sends an advertisement to a mobile device. The server is an ad-serving module. At operation 672, the ad-serving module detects the activity of forwarding the advertisement from the mobile device to another mobile device. At operation 673, the ad-serving module determines if the advertisement that was forwarded to the other mobile device includes an endorsement for the advertisement or not. The endorsement was generated at the mobile device that received the ad from the ad-serving module. The ad can be forwarded with or without endorsement. At operation 674, the ad-serving module monitors activity (or activities) on the other mobile device that receives the forwarded ad regarding the advertisement. The ad-serving module would monitor whether the ad has been viewed or not and whether the receiver has taken any action, such as making purchases or visiting web site of the ad sponsor. Method 670 can incorporate other process sequences mentioned above in related process flows or method.

The embodiments described below define wireless devices can be used to distribute and/or to endorse (or promote) advertisements (ads) by individuals and by ad distributors. In one embodiment, mobile ads are actively distributed and/or endorsed by individuals to their friends, families, and/or acquaintance and are thus more likely to be viewed. The individuals (or users) who participate in distributing and endorsing mobile ads can receive financial reward as an incentive. As mobile device users carry their mobile devices for most of their daily activities, their mobile devices can be used to receive and to distribute ads based on their environment. Mobile ad engines and methods can be set up to better match ads with targeted receivers and to assist mobile users in distributing and endorsing of ads. Thus, the excess storage and processing capabilities of wireless (or mobile) devices can be harvested to serve ads with or without the knowledge of the owners of wireless (or mobile) devices.

With the above embodiments in mind, it should be understood that the invention might employ various computer-implemented operations involving data stored in computer systems. These operations are those requiring physical manipulation of physical quantities. Usually, though not necessarily, these quantities take the form of electrical or magnetic signals capable of being stored, transferred, combined, compared, and otherwise manipulated. Further, the manipulations performed are often referred to in terms, such as producing, identifying, determining, or comparing.

The invention can also be embodied as computer readable code on a computer readable medium. The computer readable medium is any data storage device that can store data, which can be thereafter read by a computer system. The computer readable medium may also include an electromagnetic carrier wave in which the computer code is embodied. Examples of the computer readable medium include hard drives, network attached storage (NAS), read-only memory, random-access memory, CD-ROMs, CD-Rs, CD-RWs, magnetic tapes, and other optical and non-optical data storage devices. The computer readable medium can also be distributed over a network coupled computer system so that the computer readable code is stored and executed in a distributed fashion.

Any of the operations described herein that form part of the invention are useful machine operations. The invention also relates to a device or an apparatus for performing these operations. The apparatus may be specially constructed for the required purposes, or it may be a general-purpose computer selectively activated or configured by a computer program stored in the computer. In particular, various general-purpose machines may be used with computer programs written in accordance with the teachings herein, or it may be more convenient to construct a more specialized apparatus to perform the required operations.

The above-described invention may be practiced with other computer system configurations including hand-held devices, microprocessor systems, microprocessor-based or programmable consumer electronics, minicomputers, mainframe computers and the like. Although the foregoing invention has been described in some detail for purposes of clarity of understanding, it will be apparent that certain changes and modifications may be practiced within the scope of the appended claims. Accordingly, the present embodiments are to be considered as illustrative and not restrictive, and the invention is not to be limited to the details given herein, but may be modified within the scope and equivalents of the appended claims. In the claims, elements and/or steps do not imply any particular order of operation, unless explicitly stated in the claims.

What is claimed is:

1. A computer implemented method of forwarding an advertisement received on a first mobile device to a second mobile device, comprising:
sending the advertisement to the first mobile device;
detecting forwarding of the advertisement from the first mobile device to the second mobile device;
determining if the advertisement that was forwarded to the second mobile device includes an endorsement for the advertisement, wherein the endorsement was generated at the first mobile device; and
monitoring activity on the second mobile device regarding the advertisement when the advertisement includes the endorsement and when the advertisement does not include the endorsement.

2. The computer implemented method of claim 1, further comprising:
receiving registration of a plurality of mobile devices to enable tracking of forwarding and endorsing of advertisements.

3. The computer implemented method of claim 2, further comprising:
receiving a plurality of advertisements and their corresponding advertising targets; and
retrieving user profiles of the plurality of mobile devices being registered; and
matching the plurality of advertisements received with the plurality of registered mobile devices by relating the advertising targets with the user profiles.

4. The computer implemented method of claim 3, wherein the advertisement sent to the first mobile device is one of the plurality of advertisements, and wherein the first mobile device is one of the plurality of mobile devices that have registered.

5. The computer implemented method of claim 1, wherein the advertisement was forwarded to the second mobile device with the endorsement, or the advertisement was forwarded to the second mobile device without the endorsement.

6. The computer implemented method of claim 1, further comprising:
recording activities of forwarding the advertisement, the endorsement, and the advertisement, wherein recorded activities of forwarding the advertisement and the endorsement are used to calculate a reward for the first mobile device.

7. The computer implemented method of claim 6, wherein the recorded activities are used to determine the effectiveness of advertisement campaign of the advertisement.

8. The computer implemented method of claim 2, wherein the registration of the plurality of mobile devices includes checking serving devices.

9. The computer implemented method of claim 1, further comprising:
displaying the advertisement on respective screens of the first and the second mobile devices.

10. The computer implemented method of claim 6, wherein the reward encourages active promotion of the advertisement.

11. A computer implemented method of receiving and forwarding advertisements using wireless devices, comprising:
receiving and storing a plurality of advertisements and their corresponding advertising targets;
receiving and storing registration of a plurality of mobile advertisement serving devices;
retrieving user profiles of the plurality of mobile advertisements serving devices being registered;
matching the plurality of advertisements received with the plurality of registered mobile advertisement serving devices by matching the advertising targets with the user profiles, wherein personalized advertisement inventories for the plurality of the registered mobile advertisement serving devices are generated based on matching results;
downloading the personalized advertisement inventories to the plurality of registered mobile advertisement serving devices;
sensing an environment for advertisement serving by a registered mobile advertisement-serving device;
serving at least one advertisement to at least one advertising target of the at least one advertisement from the registered mobile advertisement serving devices, the serving including an endorsement generated at the serving mobile advertisement serving device; and
displaying the at least one advertisement on the at least one advertising target.

12. The computer-implemented method of claim 11, wherein the at least one advertising target is a mobile communication device or a display system in a public place.

13. The computer implemented method of claim 11, wherein the personalized advertisement inventories are downloaded with corresponding serving models for advertisement in the personalized advertisement inventories.

14. The computer implemented method of claim 13, wherein the environment for advertisement serving sensed fits one of the corresponding serving models of the personalized advertisement inventories of the registered mobile advertisement serving device.

15. The computer implemented method of claim 13, further comprising:
receiving a request to forward the advertisement to another registered advertisement serving device.

16. A system of receiving and distributing advertisements using wireless devices, comprising:
an account management system for managing account information of users of wireless devices, wherein the account management system has a user profile module that stores user profiles of the users of wireless devices;
an advertisement management system for managing advertisements, wherein the advertisement management system has an advertisement targeting module that stores profiles of wireless device users targeted by the advertisements stored in the advertisement management system; and
an advertisement serving module for delivering advertisements to the wireless devices, wherein the advertisement serving module accesses the account management system and the advertisement management system to match the advertisements in the advertisement management with the wireless devices by matching the user profiles of the wireless devices with the profiles of wireless devices users targeted by the advertisements stored in the advertisement system, and wherein the advertisement serving module assists users of the wireless devices in forwarding and endorsing advertisements received by the wireless devices, and wherein the advertisement serving module has a reward module that records advertisement forwarding and endorsing activities of the users of wireless devices.

17. The system of claim 16, wherein account management system, the advertisement management system, and the advertisement-serving module are part of an advertisement engine.

18. The system of claim 17, wherein the advertisement engine further includes a sensor and transaction manager to sense and assist the interaction between the wireless devices and the advertisement engine.

19. The system of claim 16, wherein the account management system has a storage for the users' personal profiles, a storage for the users' acquaintance profiles, a storage for places and time the users visit, and a storage for topics and activities of interests to the users.

20. The system of claim 16, wherein the advertisement management system has a storage for target geographical locations of the advertisements stored, a storage of target user profiles of the advertisements stored, and a storage of advertisement campaign periods of the advertisements stored.

21. Computer readable media including program instruction for forwarding an advertisement received on a first mobile device to a second mobile device, the computer readable media comprising:
program instruction sending the advertisement to the first mobile device;
program instruction detecting forwarding of the advertisement from the first mobile device to the second mobile device;
program instruction determining if the advertisement that was forwarded to the second mobile device includes an endorsement for the advertisement, wherein the endorsement was generated at the first mobile device; and
program instruction monitoring activity on the second mobile device regarding the advertisement when the advertisement includes the endorsement and when the advertisement does not include the endorsement.
